(19) United States
(12) Patent Application Publication
(10) Pub. No.: US 2025/0319681 A1
(43) Pub. Date: Oct. 16, 2025

(54) A METHOD OF MANUFACTURING FOOTWEAR AND FOOTWEAR MANUFACTURED BY DIRECT INJECTION PRODUCTION

(71) Applicant: ECCO Sko A/S, Bredebro (DK)

(72) Inventor: Frank Jensen, Bredebro (DK)

(21) Appl. No.: 18/868,104

(22) PCT Filed: May 23, 2023
(86) PCT No.: PCT/DK2023/050123

§ 371 Date: Nov. 21, 2024

(30) Foreign Application Priority Data
May 23, 2022 (DK) PA 2022 00484

(51) Int. Cl. B29D 35/08; A43B 13/12; B29D 35/06

(52) U.S. Cl. CPC B29D 35/081; A43B 13/125; B29D 35/061

(57) ABSTRACT

A footwear manufactured by, and a method of manufacturing footwear by, a direct injection production. The method includes providing a direct injection mold, which is attachable to injection molding equipment and is configured for at least partly channeling injection material to a mold cavity. At least one premanufactured sole part of a sole structure is provided. The premanufactured sole part is positioned in relation to the direct injection mold. A footwear upper is positioned in relation to the direct injection mold. An injection material is injected into the mold cavity, and the mold cavity is at least partly formed by the direct injection mold. The injection material is configured for attaching the footwear upper to the at least one premanufactured sole part. The injection material, upon curing, provides an attaching sole part of the sole structure of the footwear. The at least one premanufactured sole part is a sole part that has been manufactured by a supercritical foaming process.

### FIELD OF THE INVENTION

The invention relates to a method of manufacturing footwear by a direct injection production (DIP).

Further, the invention relates to footwear manufactured by direct injection production (DIP).

### BACKGROUND OF THE INVENTION

It is known in the art to manufacture footwear by means of direct injection of the sole to the upper, whereby injected material serves as a sole or part of a sole, when cured, and serves to attach the footwear upper to the sole construction.

The direct injection process (DIP) or direct injection production (DIP) as it also may be referred to in the following, is advantageous in many ways as the manufactured footwear may be produced to possess both flexibility and strength at the same time.

Various methods have been utilized in the prior art to improve the direct injection process as well as footwear produced by such methods, e.g. in order to increase production efficiency, lower costs, increase comfort to the user, etc.

US 2004/0143995 A1 discloses a direct attach footwear construction, wherein a boot is constructed with an outsole that is direct attached to a midsole which is direct attached to an upper. The outsole is manufactured from a relatively hard rubber or other sufficiently and wear-resistant material and is manufactured, e.g. injection moulded, in advance prior to the direct attachment of the outsole to the footwear.

As an example of a further footwear construction, foam articles that may serve as a cushioning element for an article of footwear, wherein the cushioning element may be a midsole, is disclosed in WO 2021/183475 A1. The cushioning element may be foamed by use of a foaming agent such as a super critical fluid comprising a supercritical nitrogen or a supercritical carbon dioxide. However, this requires further production steps, thereby increasing costs, as the midsole as disclosed by this document is joined to the footwear upper by an adhesive and the midsole is further joined to an outsole by an adhesive.

Thus, it is apparent that such cushioning elements are not suitable for direct injection production of footwear, wherein a sole construction is attached to a footwear upper by direct injection process.

### SUMMARY OF THE INVENTION

It has been realized that improvements of the method of manufacturing footwear by a direct injection process as well as improvements of footwear manufactured by such a direct injection process are desirable to reduce costs and to improve user comfort as well.

In a first aspect, the invention relates to a method of manufacturing footwear by a direct injection production (DIP), said method comprising
providing a direct injection mould, which is attachable to injection moulding equipment and is configured for at least partly channelling injection material to a mould cavity,
providing at least one premanufactured sole part of a sole structure,
positioning the premanufactured sole part in relation to the direct injection mould,
positioning a footwear upper in relation to the direct injection mould,
injecting injection material into said mould cavity, said mould cavity being at least partly formed by said direct injection mould, said injection material configured for attaching said footwear upper to said at least one premanufactured sole part, said injection material upon curing providing an attaching sole part of the sole structure of said footwear,
   wherein said at least one premanufactured sole part is a sole part that has been manufactured by a supercritical foaming process.

Hereby a footwear may be manufactured by a direct injection production (DIP), wherein a sole part that has been manufactured by a supercritical foaming process and thus comprises desirous characteristics, may readily be applied as part of the sole structure. Such desirous characteristics of a sole part that has been manufactured by a supercritical foaming process may be for example a softer sole that weighs less than a sole part that is made for example of foamed PU (Polyurethane), e.g. PU that is injected in the DIP process and expanded/cured in the DIP mould. Furthermore, less energy may be used in the manufacturing process when using a sole part manufactured by a supercritical foaming process in a DIP process.

Thus, by the invention it is achieved that a direct injection production process (DIP) can be applied for footwear constructions, wherein a sole part that has been manufactured by a supercritical foaming process is comprised and whereby separate joining processes may be avoided.

According to an embodiment, said attaching sole part that serves for attaching said footwear upper to said at least one premanufactured sole part, may serve as at least part of a further sole part of the sole structure of said footwear.

Thus, it will be understood that the attaching sole part may be constituted by a relatively thin layer of injected material that expands and cures. Also, it will be understood that such a relatively thin layer of injected material may not have a homogenous thickness but may comprise one or more areas having an increased thickness, e.g. in view of the configuration of the respective surfaces of the e.g. bottom surface of the footwear upper and the premanufactured sole part and in view of the mutual positioning of the bottom surface of the footwear upper and the premanufactured sole part. Thus, a footwear may be manufactured by a direct injection production (DIP), wherein the attaching sole part may further serve as a sole part in itself, e.g. as a midsole, part of a midsole, an additional midsole or other sole parts that e.g. may attach the footwear upper to a lower placed part of the sole structure such as an outsole or a midsole.

According to an embodiment, said at least one premanufactured sole part may be configured to form an outsole.

Hereby it may be achieved that a footwear may be manufactured by a direct injection production (DIP), wherein the outsole is provided as a premanufactured part that has increased softness and being in lightweight form, i.e. with low density, thus meaning that the outsole may have a desired thickness without adversely affecting the weight of the finished footwear. Thus, it is possible to manufacture footwear by a DIP process having outsoles which have increased thicknesses as compared to hitherto DIP manufactured footwear wherein outsoles made of e.g. PU have been used, and still having a lighter total weight as compared to the traditionally manufactured footwear.

According to an embodiment, said at least one premanufactured sole part may be configured to form a midsole.

Hereby it may be achieved that a footwear may be manufactured by a direct injection production (DIP), wherein a midsole is provided as a premanufactured part that has increased softness and being in lightweight form, i.e. with low density, thus meaning that the midsole may have a desired thickness without adversely affecting the weight of the finished footwear. Thus, it is possible to manufacture footwear by a DIP process having midsoles which have increased thicknesses as compared to hitherto DIP manufactured footwear wherein midsoles made of e.g. PU have been used, and still having a lighter total weight as compared to the traditionally manufactured footwear.

It is noted that in such a case, an outsole may have been attached to the premanufactured midsole by e.g. adhesive or in any other suitable manner in advance.

According to an embodiment, said attaching sole part that is at least partly provided by said injection material upon curing, may form at least part of a midsole.

Hereby it may be achieved that a footwear may be manufactured by a direct injection production (DIP), wherein the at least one premanufactured and super critically foamed sole part may be attached directly by the midsole, i.e. by the injection material, to the upper of the footwear or to another part of the footwear.

Thus, the advantages of the DIP manufacturing process may be used fully.

According to an embodiment, said at least one premanufactured sole part may be premanufactured by subjecting a basic part to a supercritical foaming agent, whereby the basic part is expanded into a preform.

Hereby, a basic part that has been manufactured using e.g. granular thermoplastic materials that have been injected into an initial “baby size” form, is subjected to the supercritical foaming agent and expanded into a preform, which as regards form, size, etc. corresponds to the actual size of the actual footwear, but such that the premanufactured sole part may be positioned into the direct injection mould. During the direct injection process, wherein the heated injection material is injected and thus subjecting heat and pressure to the parts in the mould, the premanufactured sole part will take its final form as regulated by the direct injection mould.

According to an embodiment, said supercritical foaming agent may be a gas such as carbon dioxide (CO2) and/or Nitrogen.

Hereby, the supercritical foaming may be performed in a manner whereby the premanufactured sole part may be manufactured, e.g. foamed, using gasses that are natural ingredients in the atmospheric air and thus do not represent any disadvantages as regards toxic and/or other environmentally undesirous characteristics. Further, such gasses may be recyclable in gas recovery facilities.

According to an embodiment, said at least one premanufactured sole part may comprise TPU (Thermoplastic Polyurethane), TPE (Thermoplastic Elastomer), PEBAX® (Polyether Block Amide), natural rubber, synthetic rubber, ethylene vinyl acetate (EVA) and/or polyvinyl chloride (PVC).

Other materials may be used instead or additionally.

According to an embodiment, said injection material may comprise PU (Polyurethane), latex, polyvinyl chloride (PVC), and/or thermoplastic rubber (TR).

Other materials may be used instead or additionally.

According to an embodiment, said at least one premanufactured sole part may be configured with a ground facing surface and a foot facing surface, wherein said foot facing surface comprises at least one indentation for receiving injection material.

Hereby, it may be achieved that the soft and low-density material of the premanufactured and super critically foamed sole part, e.g. the outsole, may be affected by the harder material of the injection material, e.g. PU that in connection with the injection and/or expansion will enter the at least one indentation. Upon curing, when the injected material of e.g. a midsole has been attached to the e.g. outsole, the cured material in the at least one indentation will have a strengthening effect on the softer material of the e.g. outsole, depending on the size and shape of the at least one indentation.

It is apparent that the indentation may have any shape and size and that as specified at least one indentation may be present, e.g. one, two, three, etc.

According to an embodiment, said at least one indentation for receiving injection material that is comprised in said foot facing surface may form a groove along the foot facing surface.

Hereby, it may be achieved that the soft and low-density material of the premanufactured and super critically foamed sole part, e.g. the outsole, may be affected by the harder material of the injection material, e.g. PU, such that an increased rigidity may be achieved in a direction along the direction of the at least one indentation. Hereby, the e.g. softness and the flexibility of the e.g. outsole may be designed by the lay-out of the at least one indentation/groove and/or by the depth of the at least one indentation/groove.

According to an embodiment, said at least one indentation for receiving injection material that forms a groove along the foot facing surface, may be extending in a longitudinal and/or transversal direction of the footwear.

Hereby, it may be achieved that an increased rigidity may be achieved in a direction along the longitudinal direction of the footwear and/or along a direction transverse to the longitudinal direction of the footwear. Hereby, the e.g. softness and the flexibility of the e.g. outsole may be designed by the lay-out, e.g. direction of the at least one indentation/groove and/or by the depth of the at least one indentation/groove.

According to an embodiment, said at least one indentation for receiving injection material that forms a groove along the foot facing surface, may be extending in a direction that essentially forms an angle different from 0° in relation to the longitudinal direction of the footwear.

Hereby, further options for configuring the footwear to obtain a desired e.g. softness and flexibility of the e.g. outsole may be achieved, e.g. by designing the lay-out, e.g. direction/angle of the at least one indentation/groove and/or by the depth of the at least one indentation/groove.

According to an embodiment, said at least one indentation for receiving injection material that forms a groove along the foot facing surface, may be extending essentially linearly, in angular forms and/or in curved forms.

Hereby, even further options for configuring the footwear to obtain a desired e.g. softness and flexibility of the e.g. outsole may be achieved, e.g. by designing the lay- out, e.g. direction/angle and/or form of the at least one indentation/groove and/or by the depth of the at least one indentation/groove.

According to an embodiment, said at least one indentation for receiving injection material may extend through said at least one premanufactured sole part.

Hereby, even further options for configuring the footwear to obtain a desired e.g. softness and flexibility of the e.g. outsole may be achieved, e.g. by having one or more parts of the injected material reaching through the premanufactured sole part and thus possibly forming part of the ground facing surface of the outsole, thereby influencing also on the characteristics of the ground facing surface of the outsole such as e.g. friction to the ground, rigidity, wear resistance of the outsole, etc.

According to an embodiment, said at least one indentation for receiving injection material may be configured asymmetrically in/on said foot facing surface.

Hereby, the support of the sole, e.g. hardness, the comfort etc. may be adapted to the user, e.g. with the indentation areas, when filled with the relatively hard composition of the cured injection material as compared to the softer SCF foamed material of the premanufactured sole part, may provide load bearing areas, e.g. at the heel and the ball of the foot, while the softer SCF foamed material may provide a larger degree of comfort at other areas. Furthermore, it will be understood that such a “tuning” of hardness/comfort, e.g. to achieve a variable hardness, may be utilized to adapt the footwear in view of specific users, e.g. in order to provide larger support at the medial side or at the lateral side, etc.

According to an embodiment, said at least one indentation for receiving injection material may be configured for providing a variable hardness and/or support of the sole structure.

According to an embodiment, said at least one premanufactured sole part may comprise a bonding layer on at least part of a surface subjected to said injection

Hereby, the adherence to the injection material, once cured and thus the adherence to the attaching sole part may be facilitated, e.g. increased and made stronger.

According to an embodiment, said bonding layer may comprise materials such as glue, textile, woven or non-woven materials, scrim, etc.

According to an embodiment, at least part of said surface subjected to said injection material may be void of said bonding layer, e.g. bottom and/or sides of indentations, etc.

Hereby, the adherence to the indentations may thus be lessened, which may be taken into consideration when configuring e.g. the variable hardness and the comfort of the sole structure.

In a second aspect, the invention relates to a footwear manufactured by direct injection production (DIP), said footwear comprising
a footwear upper
at least one premanufactured sole part,
at least one further sole part of said footwear,
wherein said at least one premanufactured sole part is a sole part that has been manufactured by a super critical foaming process and
wherein said at least one further sole part of said footwear has been at least partly manufactured by injecting injection material into a mould cavity that is at least partly formed by a direct injection mould, and wherein said injection material has attached said footwear upper to said at least one premanufactured sole part.

Hereby a footwear may be provided that is manufactured by a direct injection production (DIP), wherein a sole part that has been manufactured by a supercritical foaming process and thus comprises desirous characteristics, may readily be applied as part of the sole structure of the footwear. Such desirous characteristics of a sole part that has been manufactured by a supercritical foaming process may be for example a softer sole that weighs less than a sole part that is made for example of foamed PU (Polyurethane). Furthermore, less energy may be used in the manufacturing process when using a sole part manufactured by a supercritical foaming process in a DIP process. Thus, the footwear according to the invention may be provided in a lightweight form and with a softer sole structure as compared to prior art DIP manufactured footwear.

By the invention a footwear is provided that may readily be manufactured by a direct injection production process (DIP) and wherein a sole part that has been manufactured by a supercritical foaming process is comprised, thus avoiding separate joining processes of sole part(s) and the upper, whereby a cost efficient production may be achieved.

According to an embodiment, said at least one premanufactured sole part may be configured to form an outsole.

Hereby it may be achieved that the footwear may be manufactured by a direct injection production (DIP), wherein the outsole is provided as premanufactured part that has increased softness and being in lightweight form, i.e. with low density, thus meaning that the outsole may have a desired thickness without adversely affecting the weight of the finished footwear. Thus, it is possible to manufacture footwear by a DIP process having outsoles which have increased thicknesses as compared to hitherto DIP manufactured footwear wherein outsoles made of e.g. PU have been used, and still having a lighter total weight as compared to the traditionally manufactured footwear.

According to an embodiment, said further sole part of said footwear that is at least partly provided by said injection material may be a midsole.

Hereby it may be achieved that the footwear may be manufactured by a direct injection production (DIP), wherein the at least one premanufactured and super critically foamed sole part may be attached directly by the midsole, i.e. by the injection material, to the upper of the footwear or to another part of the footwear.

According to an embodiment, said at least one premanufactured sole part may have been premanufactured by subjecting a basic part to a supercritical foaming agent, whereby the basic part is expanded into a preform.

Hereby, a basic part that has been manufactured using e.g. granular thermoplastic materials that have been injected into an initial “baby size” form, is subjected to the supercritical foaming agent and expanded into a preform, which as regards form, size, etc. corresponds to the actual size of the actual footwear, but such that the premanufactured sole part may be positioned into the direct injection mould. During the direct injection process, wherein the heated injection material is injected and thus subjecting heat and pressure to the parts in the mould, the premanufactured sole part will take its final form as regulated by the direct injection mould.

According to an embodiment, said supercritical foaming agent may be a gas such as carbon dioxide (CO2) and/or Nitrogen.

Hereby, the supercritical foaming may be performed in a manner whereby the premanufactured sole part may be manufactured, e.g. foamed, using gasses that are natural ingredients in the atmospheric air and thus do not represent any disadvantages as regards toxic and/or other environmentally undesirous characteristics. Further, such gasses may be recyclable in gas recovery facilities. Thus, the footwear may be produced in an environmental-friendly manner.

According to an embodiment, said at least one premanufactured sole part may comprise TPU (Thermoplastic Polyurethane), TPE (Thermoplastic Elastomer), PEBAX® (Polyether Block Amide), natural rubber, synthetic rubber, ethylene vinyl acetate (EVA) and/or polyvinyl chloride (PVC).

According to an embodiment, said injection material may comprise PU (Polyurethane), latex, polyvinyl chloride (PVC), and/or thermoplastic rubber (TR).

According to an embodiment, said at least one premanufactured sole part may be configured with a ground facing surface and a foot facing surface, wherein said foot facing surface may comprise at least one indentation for receiving injection material.

Hereby, it may be achieved that the soft and low-density material of the premanufactured and super critically foamed sole part, e.g. the outsole, may be affected by the harder material of the injection material, e.g. PU that in connection with the injection and/or expansion will enter the at least one indentation. Upon curing, when the injected material of e.g. a midsole has been attached to the e.g. outsole, the cured material in the at least one indentation will have a strengthening effect on the softer material of the e.g. outsole, depending on the size and shape of the at least one indentation.

It is apparent that the indentation may have any shape and size and that as specified at least one indentation may be present, e.g. one, two, three, etc.

Thus, the footwear may according to this embodiment be designed with desired properties as regards the softness, flexibility and/or rigidity of the sole structure.

According to an embodiment, said at least one indentation for receiving injection material that is comprised in said foot facing surface may form a groove along the foot facing surface.

Hereby, it may be achieved that the soft and low-density material of the premanufactured and super critically foamed sole part, e.g. the outsole, may be affected by the harder material of the injection material, e.g. PU, such that an increased rigidity may be achieved in a direction along the direction of the at least indentation. Hereby, the e.g. softness and the flexibility of the e.g. outsole may be designed by the lay-out of the at least one indentation/groove and/or by the depth of the at least one indentation/groove.

According to an embodiment, said at least one indentation for receiving injection material that forms a groove along the foot facing surface, may be extending in a longitudinal and/or transversal direction of the footwear.

Hereby, it may be achieved that an increased rigidity may be achieved in a direction along the longitudinal direction of the footwear and/or along a direction transverse to the longitudinal direction of the footwear. Hereby, the e.g. softness and the flexibility of the e.g. outsole may be designed by the lay-out, e.g. direction of the at least one indentation/groove and/or by the depth of the at least one indentation/groove.

According to an embodiment, said at least one indentation for receiving injection material that forms a groove along the foot facing surface, may be extending in a direction that essentially forms an angle different from 0° in relation to the longitudinal direction of the footwear.

Hereby, further options for configuring the footwear to obtain a desired e.g. softness and flexibility of the e.g. outsole may be achieved, e.g. by designing the lay-out, e.g. direction/angle of the at least one indentation/groove and/or by the depth of the at least one indentation/groove.

According to an embodiment, said at least one indentation for receiving injection material that forms a groove along the foot facing surface, may be extending essentially linearly, in angular forms and/or in curved forms.

Hereby, even further options for configuring the footwear to obtain a desired e.g. softness and flexibility of the e.g. outsole may be achieved, e.g. by designing the lay- out, e.g. direction/angle and/or form of the at least one indentation/groove and/or by the depth of the at least one indentation/groove.

According to an embodiment, said at least one indentation for receiving injection material may extend through said at least one premanufactured sole part.

Hereby, even further options for configuring the footwear to obtain a desired e.g. softness and flexibility of the e.g. outsole may be achieved, e.g. by having one or more parts of the injected material reaching through the premanufactured sole part and thus possibly forming part of the ground facing surface of the outsole, thereby influencing also on the characteristics of the ground facing surface of the outsole such as e.g. friction to the ground, rigidity, wear resistance of the outsole, etc.

According to an embodiment, said at least one indentation for receiving injection material may be configured asymmetrically in/on said foot facing surface.

Hereby, the support of the sole, e.g. hardness, the comfort etc. may be adapted to the user, e.g. with the indentation areas, when filled with the relatively hard composition of the cured injection material as compared to the softer SCF foamed material of the premanufactured sole part, may provide load bearing areas, e.g. at the heel and the ball of the foot, while the softer SCF foamed material may provide a larger degree of comfort at other areas. Furthermore, it will be understood that such a “tuning” of hardness/comfort, e.g. to achieve a variable hardness, may be utilized to adapt the footwear in view of specific users, e.g. in order to provide larger support at the medial side or at the lateral side, etc.

According to an embodiment, said at least one indentation for receiving injection material may be configured for providing a variable hardness and/or support of the sole structure.

According to an embodiment, said at least one premanufactured sole part may comprise a bonding layer on at least part of a surface subjected to said injection

Hereby, the adherence to the injection material, once cured and thus the adherence to the attaching sole part may be facilitated, e.g. increased and made stronger.

According to an embodiment, said bonding layer may comprise materials such as glue, textile, woven or non-woven materials, scrim, etc.

According to an embodiment, at least part of said surface subjected to said injection material may be void of said bonding layer, e.g. bottom and/or sides of indentations.

Hereby, the adherence to the indentations as such may thus be lessened, which may be taken into consideration when configuring e.g. the variable hardness and the comfort of the sole structure.

According to an embodiment, said footwear may have been manufactured by a direct injection production (DIP) method according to any one of claims 1 to 20.

### THE FIGURES

The invention will be explained in further detail below with reference to the figures of which

FIG. 1 shows a schematically illustrated last and direct injection mould, seen in a cross-sectional view, as used for direct injection moulding of footwear according to a prior art,

FIG. 2 shows the schematically illustrated last and direct injection mould as shown in FIG. 1, but in a closed position and with injection material injected in a mould cavity,

FIG. 3 shows in a similar manner the schematically illustrated last and direct injection mould as shown in FIG. 1, but in a closed position after the injection material has been injected and expanded in the mould cavity, shows a flow diagram illustrating steps involved in an embodiment of a FIG. 4 method according to the invention,

FIG. 5 is a further flow diagram, illustrating further steps involved for providing a premanufactured sole part manufactured by a supercritical foaming process,

FIG. 6 shows a DIP mould being utilized for manufacturing footwear according to an embodiment of the invention, wherein a premanufactured sole part is utilized,

FIG. 6a corresponds to FIG. 6, but wherein a bonding layer is shown on the premanufactured sole part,

FIG. 7 shows a DIP mould being utilized for manufacturing footwear in a manner corresponding to FIG. 6, but wherein indentations are comprised in the premanufactured sole part,

FIG. 7a corresponds to FIG. 7, but wherein a bonding layer is shown on parts of the premanufactured sole part

FIGS. 8a-f show an embodiment of a footwear manufactured by an embodiment of the invention,

FIGS. 9a-f show an embodiment of a footwear manufactured by an embodiment of the invention, wherein the premanufactured sole part comprises one or more indentations,

FIGS. 10a-f show an embodiment of a footwear manufactured by an embodiment of the invention, also wherein the premanufactured sole part comprises indentations,

FIGS. 11a-f show an embodiment of a footwear manufactured by an embodiment of the invention, wherein the premanufactured sole part comprises various indentations,

FIGS. 12a-f show an embodiment of a footwear manufactured by an embodiment of the invention, wherein the premanufactured sole part comprises a plurality of indentations,

FIGS. 13a-f show an embodiment of a footwear manufactured by an embodiment of the invention, wherein the premanufactured sole part comprises indentations protruding through the sole,

FIGS. 14a-f show an embodiment of a footwear manufactured by an embodiment of the invention, wherein the premanufactured sole part comprises indentations placed in the perimeter of the sole,

FIGS. 15a-f show an embodiment of a footwear manufactured by an embodiment of the invention, showing a further example of a premanufactured sole part comprising indentations placed in the perimeter of the sole,

FIGS. 16a-f show an embodiment of a footwear manufactured by an embodiment of the invention, wherein the premanufactured sole part comprises indentations placed mainly in the perimeter of the heel part of the sole, show an embodiment of a footwear manufactured by an embodiment of FIGS. 17a-f the invention, wherein the premanufactured sole part comprises an indentation placed in the perimeter at one side of the sole,

FIGS. 18a-f show an embodiment of a footwear manufactured by an embodiment of the invention, wherein the premanufactured sole part comprises relatively large indentations, one at the heel area and one at the forefoot area,

FIGS. 19a-f show an embodiment of a footwear manufactured by an embodiment of the invention, wherein the premanufactured sole part comprises indentations placed essentially in a transverse direction of the sole, and

FIGS. 20a-f show an embodiment of a footwear manufactured by an embodiment of the invention, wherein the premanufactured sole part comprises indentations formed in and distributed on the foot facing surface to adapt the support and comfort functionality of the sole to the user.

### DETAILED DESCRIPTION

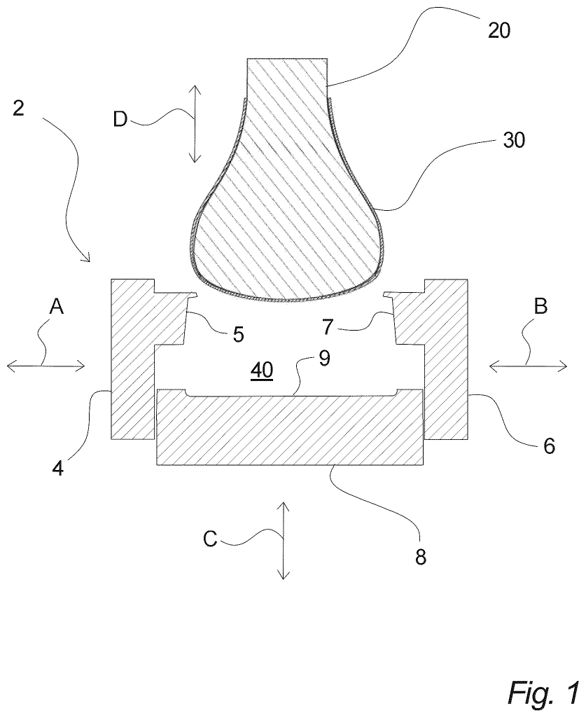

With reference to FIG. 1 a prior art DIP moulding method and system will be elucidated. This figure shows schematically a direct injection mould 2 and a last 20, both seen in a cross-sectional view taken e.g. vertically in an ankle area of the footwear, which last 20 and mould 2 may be utilized for direct injection moulding of footwear according to the prior art. The direct injection mould 2 may have been made out of metal, for example aluminium by e.g. CNC machinery and may as shown in FIG. 1 comprise a first side mould 4, a second side mould 6 and a bottom mould 8, which are arranged in such a manner that the mould 2 may be opened and closed, e.g. by the first side mould 4 and the second side mould 6 being able to be moved in horizontal directions as indicated with the arrows A, B, respectively, and by the bottom mould 8 being arranged to be moved in the vertical direction as indicated with the arrow C. As shown in FIG. 1, the first side mould 4 and the second side mould 6 may be provided with a first side surface 5 and a second side surface 7, respectively, that have been made during the e.g. CNC milling, and which generally define a desired form of a side part of a shoe sole to be moulded. Further, the bottom mould 8 may correspondingly be provided with a bottom inner surface 9, which has been made during the e.g. CNC milling and which generally has a form corresponding to a desired form of the underside of the shoe sole to be moulded.

Further, it is shown in FIG. 1 that a footwear upper 30 may be put onto the last 20 and that the last 20 with the footwear upper 30 can be moved in various directions including downwards in relation to the mould 2 as indicated with the arrow D. It will be understood that when performing such a step, it is required that the mould 2 is in an open state in order to allow the last 20 to move down towards the mould and enter a suitable distance into the mould 2 such that the circumference of the closed mould will coincide with the footwear upper 30 as carried by the last 20. When the last 20 has been moved downwards, the mould 2 may be closed, thus forming a mould cavity 40 between the footwear upper 30, the first side mould 4, the second side mould 6 and the bottom mould 8. The mould 2 is attached to injection moulding equipment (not shown in FIG. 1), by means of which injection material is injected into the mould cavity, where the injected material comes into contact with the first side surface 5, the second side surface 7, the bottom inner surface 9 and the bottom parts of the footwear upper 30. When the injected material has taken the shape of the mould cavity, it is being cured.

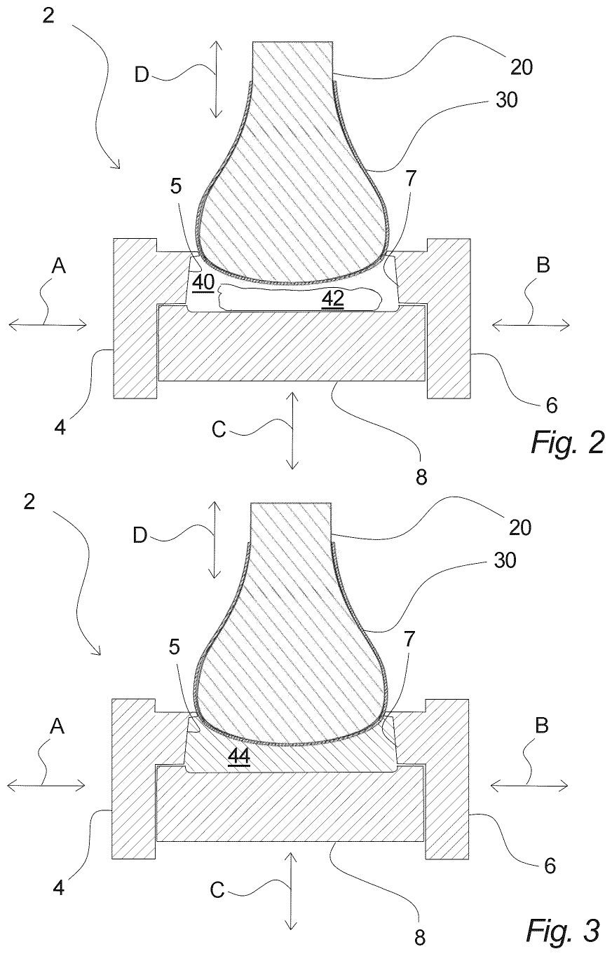

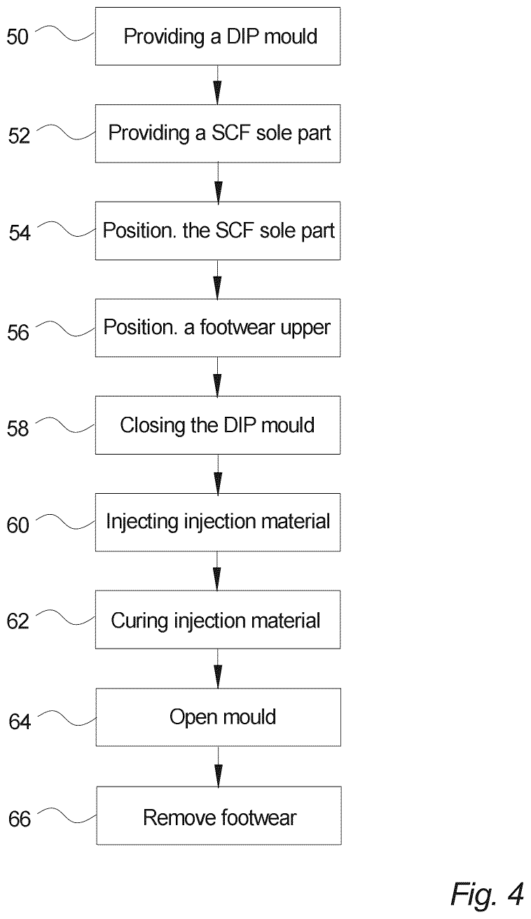

Further details of the direct injection mould and the moulding process will be understood from the following, wherein FIGS. 2 and 3 serve to further illustrate the direct injection process.

FIG. 2 shows the scenario where the bottom mould 8 has been moved upwards in a vertical direction C, thus closing the mould cavity 40. When the footwear direct injection mould 2 is closed, the mould cavity 40 is closed to the surrounding environment, ensuring that the injected material 42, which is illustrated in FIG. 2 as having just been injected, will take the shape of the mould cavity 40.

FIG. 3 shows a scenario where the injected material 42 has expanded to fill out the entire volume of the mould cavity 40, where the injected material 42 comes into contact with the inner surfaces of the first side surface 5, the second side surface 7 and the bottom inner surface 9 (FIG. 1) as well as bottom parts of the footwear upper 30, causing the outer surface of the injected material 42 to take the shape of the mould cavity and the respective inner surfaces and the lower surface of the footwear upper 30 to form a footwear sole 44. It is noted that the injected material 42, e.g. when expanding, attaches to the bottom parts of the footwear upper 30. The inner surfaces of the direct injection mould 2, e.g. the first side surface 5, the second side surface 7 and the bottom inner surface 9 may be prepared not to attach to the injected material, e.g. by application of slip/anti-stick means.

When the injected material 42 has been cured, the first 4 and second side mould 6 may be moved in a horizontal movement outwards as indicated with the double-arrows A and B, respectively, shown in FIG. 3, and the bottom mould 8 may be moved downwards as indicated with the double-arrow C shown in FIG. 3, thereby opening the footwear direct injection mould 2. The movement of the first side mould 4, the second side mould 6 and the bottom mould 8 remove the mould inner surfaces from the injected material 42 and the last 20 and the upper 30 with the sole 44 attached may be removed from the mould 2.

It is noted that e.g. a separate outsole (not shown in FIGS. 2 and 3) may be positioned within the mould 2 on the bottom mould 8 before the mould is closed, such that the outsole may be attached to the bottom part of the cured sole 44 upon curing.

To illustrate an embodiment of the method according to the invention, reference will be made to FIG. 4, which shows a flow diagram illustrating steps involved in such an embodiment. Here, a direct injection (DIP) mould is provided at step 50 and at step 52 a premanufactured sole part is provided, which sole part is manufactured by a supercritical foaming process, including subjecting it to a supercritical fluid (SCF), and which may be referred to as a SCF sole part. This SCF sole part is positioned in the DIP mould at step 54 and further a footwear upper, e.g. carried by a last, is positioned in relation to the DIP mould at step 56. Next, the DIP mould is closed at 58 and the injection material is injected at 60 in an amount, suitable to fill the mould cavity between the footwear upper and the premanufactured sole part, when the injection material has expanded. The injection material subsequently is cured, as indicated at 62, which is performed under certain temperature and pressure conditions, which furthermore facilitates that the premanufactured sole part expands to take the shape as determined by e.g. the DIP mould. Upon curing, the DIP mould is opened at 64 and the manufactured footwear is removed at 66, whereafter possible further processing steps may be performed, such as removal of surplus injection material, etc.

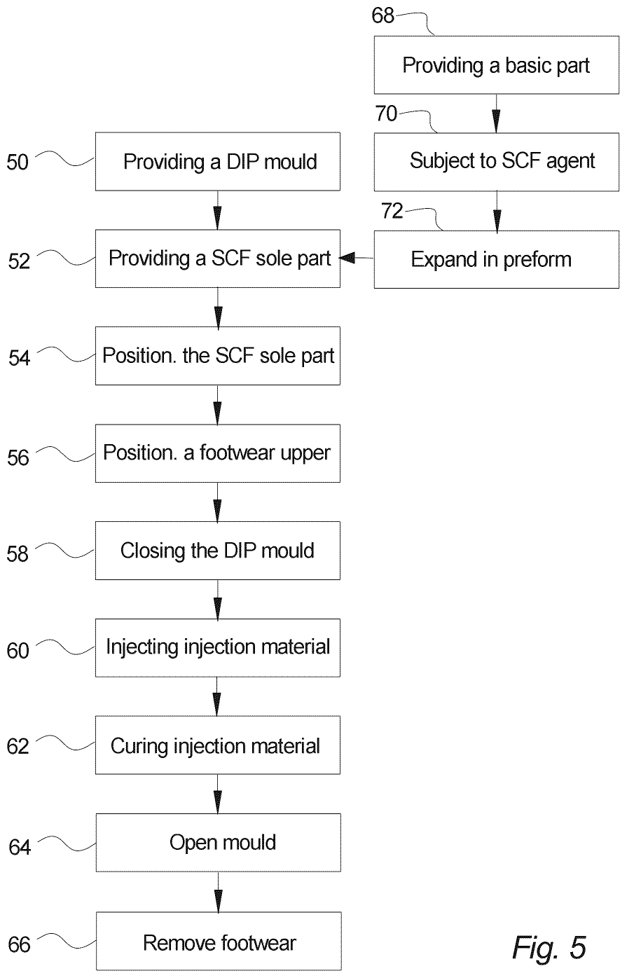

FIG. 5 corresponds to FIG. 4, but in FIG. 5 steps involved for providing the SCF sole part are illustrated, including the step of providing a basic part at 68, which basic part has been manufactured using e.g. granular thermoplastic materials, “virgin” and/or re- used materials that are injected into a basic form to produce a basic part of the sole part, e.g. a part which is of “baby size”. As illustrated in step 70, this basic part is subjected to an SCF agent such as carbon dioxide (CO2) and/or Nitrogen in supercritical form, and the basic part is at step 72 expanded into a preform to a form and size essentially corresponding to the final form and size of the finished sole part, possibly after having been pressed to the final form and in order to allow it to be entered into the DIP mould.

It is noted that the steps e.g. 68, 70 and 72 involved in providing the SCF sole part are according to various embodiments performed separately from the DIP process as such and that the SCF sole parts that may be provided in the DIP process in step 52, may have been premanufactured and provided in the respective forms, sizes etc. in advance, ready to be introduced into the DIP process. However, it is a possibility that the production of the SCF sole part and the DIP process for manufacturing footwear comprising one or more of such SCF sole parts may take place in production lines e.g. side by side.

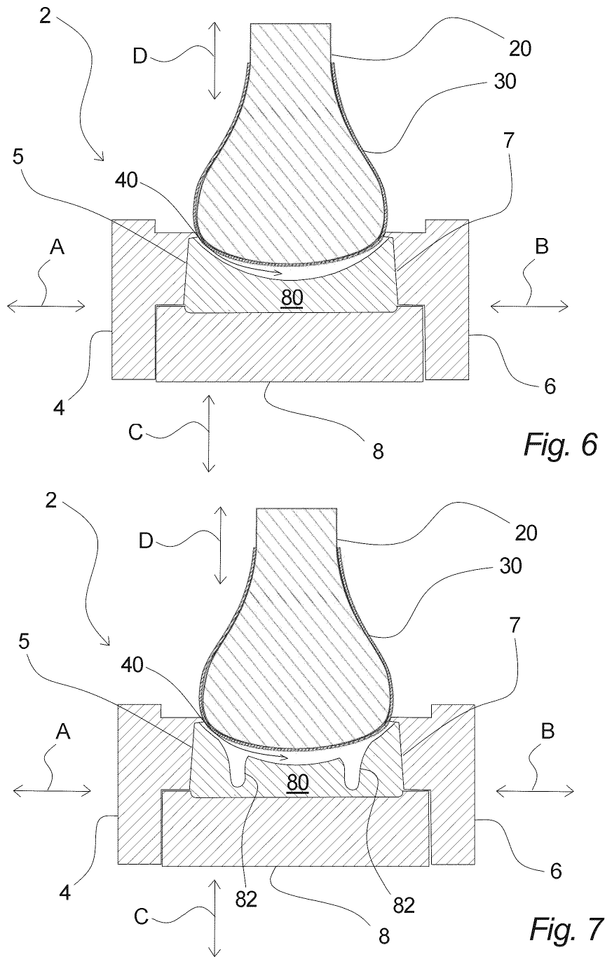

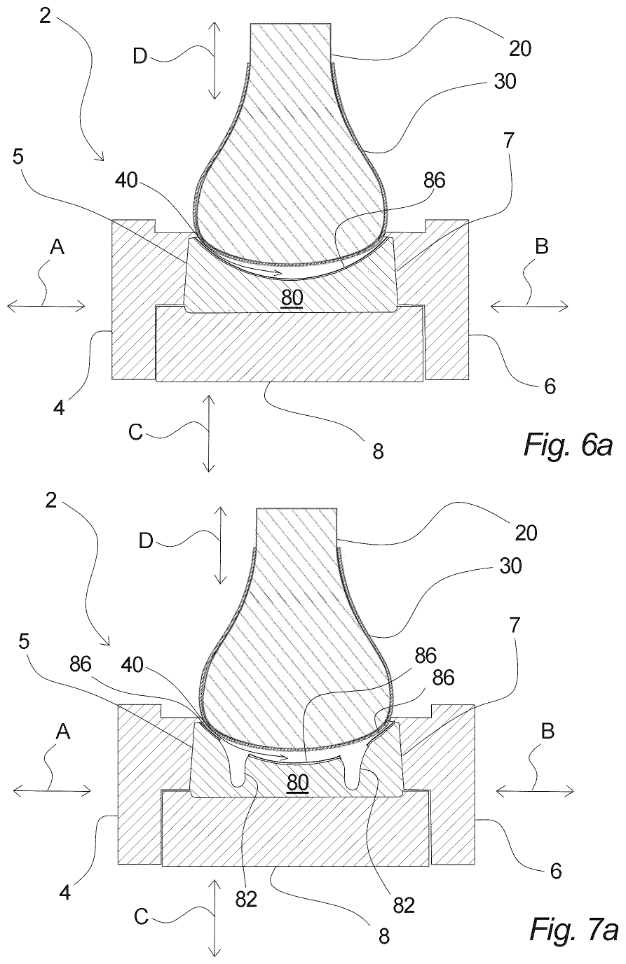

FIG. 6 shows in a schematic manner a direct injection mould 2 and a last 20, both seen in a cross-sectional view taken e.g. vertically in an ankle area of the footwear, which last 20 and mould 2 may be utilized for direct injection moulding of footwear according to a method according to an embodiment of the invention.

In FIG. 6 the scenario is shown, wherein a premanufactured sole part 80, which has been manufactured by a supercritical foaming process, has been positioned within the direct injection mould 2, e.g. when this has been in an open state. Subsequent to this, the last 20 carrying the footwear upper 30 has been moved down towards the mould and entered a suitable distance into the mould 2 such that the circumference of the closed mould will coincide with the footwear upper 30 as carried by the last 20. After the last 20 has been moved downwards, the mould 2 has been closed, thus forming a mould cavity 40 as indicated between the footwear upper 30, the first side mould 4, the second side mould 6 and the premanufactured sole part 80.

It is noted that the premanufactured sole part 80, which as mentioned above has been manufactured by a supercritical foaming (SCF) process, fills a large part of the volume as defined by the footwear upper 30, the first side mould 4, the second side mould 6 and the bottom mould 8 and is formed to essentially comply to the form as defined by the first side surface 5 and the second side surface 7 along the perimeter of the premanufactured sole part 80.

However, as indicated in FIG. 6, space is left between the bottom of the footwear upper 30, the first side surface 5, the second side surface 7 and the premanufactured sole part 80, which space provides the mould cavity 40 in accordance with embodiments of the present invention. Thus, when injection material is injected in a suitable amount by injection moulding equipment (not shown in FIG. 6) into the mould cavity 40, the injected material will eventually come into contact with the first side surface 5, the second side surface 7, the bottom parts of the footwear upper 30 and the premanufactured sole part 80 as the injected material expands and subsequently is cured.

Thus, the injected material will serve to attach the premanufactured sole part 80 to the footwear upper 30 and upon curing the DIP mould may be opened and the manufactured footwear may be removed, whereafter possible further processing steps may be performed, such as removal of surplus injection material, etc.

As noted above, the premanufactured sole part 80 has according to this embodiment been manufactured by a supercritical foaming process and thus comprises certain desirable characteristics, such as for example providing a softer sole that weighs less than a sole part that is made for example of foamed PU (Polyurethane). Furthermore, less energy may be used in the manufacturing process when using a sole part manufactured by a supercritical foaming process in a DIP process. Even further, it is noted that the premanufactured sole part is in a lightweight form, i.e. with low density due to the supercritical foaming process, thus meaning that the outsole of the manufactured footwear may have a desired thickness, e.g. large thickness, without adversely affecting the weight of the finished footwear. Thus, it is possible to manufacture footwear by a DIP process having outsoles which have increased thicknesses as compared to prior art DIP manufactured footwear wherein outsoles made of e.g. PU have been used, and still having a lighter total weight as compared to the traditionally manufactured footwear.

In the example of an embodiment of the invention as shown in FIG. 6, the premanufactured sole part 80 is shown as being an outsole, i.e. with its lower surface being the surface of the sole contacting the ground during normal use.

However, it is noted that the premanufactured sole part 80 may serve as a midsole, in which case an outsole (not shown in FIG. 6) is attached to the ground facing surface of the premanufactured sole part 80, e.g. by an adhesive, before the assembled premanufactured sole part 80 and outsole is positioned in the direct injection mould 2. The remaining part of the process will be essentially as described in connection with FIG. 6, e.g. meaning that a space is left between the bottom of the footwear upper 30, the first side surface 5, the second side surface 7 and the premanufactured sole part 80 (to which is attached the outsole to its lower side), which space provides the mould cavity 40 in accordance with embodiments of the present invention. Thus, when injection material is injected in a suitable amount by injection moulding equipment into the mould cavity 40, the injected material will eventually come into contact with the first side surface 5, the second side surface 7, the bottom parts of the footwear upper 30 and the premanufactured sole part 80 assembled with the outsole as the injected material expands and subsequently is cured.

Other variations of the footwear manufacturing process are possible, wherein a premanufactured sole part is used and wherein the direct injection process (DIP) provides attachment of the premanufactured sole part to the footwear configuration.

The scenario shown in FIG. 6a corresponds to FIG. 6, but in FIG. 6a it is shown that a bonding layer 86 may be applied, e.g. a thin layer placed on the surface of the premanufactured sole part 80 to facilitate that the injection material, when cured, is solidly adhered to the premanufactured sole part 80. Such a bonding layer may comprise materials such as glue, adhesive, textile, woven or non-woven materials, scrim, etc.

In case of applying glue as a bonding layer, various glues may be utilized such as for example Glue Loctite Bondace 2520-2, Hardener Loctite Bondace RFE TH (TPFE), Hardener Loctite Bondace ARF-12, Glue Loctite Bondace 223-2, Hardener Loctite Bondace ARF-1000, etc. However, it will be apparent to a skilled person that other types and variants may be used.

As described above in connection with FIG. 6, the premanufactured sole part 80 has, due to being manufactured by a supercritical foaming process, certain desirable characteristics, such as for example a softer sole that weighs less than a sole part that is made for example of foamed PU (Polyurethane). It is noted that the premanufactured sole part is in a lightweight form, i.e. with low density due to the supercritical foaming process, thus meaning that the outsole of the manufactured footwear may have a desired thickness, e.g. large thickness, without adversely affecting the weight of the finished footwear.

However, in case e.g. a relatively thick outsole having a relatively soft structure is found inconvenient, e.g. due to being too flexible or for other reasons, it may be desired to adapt the characteristics of the assembled sole construction. This may be done by utilizing the characteristics of the injection material, e.g. PU, which may be harder than the material of the premanufactured and super critically foamed sole part, as it will be elucidated in the following.

In FIG. 7 a DIP mould 2 is shown being utilized for manufacturing footwear in a manner corresponding to FIG. 6, but wherein (one or more) indentations 82 are comprised in the premanufactured sole part 80. As the premanufactured sole part 80 due to being made by a supercritical foaming process has an increased softness, a low density and thus also a low weight and therefore may be made with an increased thickness without adversely affecting weight, it may nevertheless be desired to adapt the softness and the flexibility of the sole to achieve a desired rigidity and/or stability. This may be achieved as illustrated in FIG. 7 by having the premanufactured sole part 80 being provided with one or more indentations 82. When the premanufactured sole part 80 is provided with such indentations 82 that face the upper surface (the foot facing surface) of the premanufactured sole part 80, it will be understood that the injection material 42, when injected into the mould cavity 40, will fill and expand into the indentations 82. When the injection material has cured, it will be attached to the bottom of the footwear upper as well as the upper surface of the premanufactured sole part 80, including the indentations 82 and the surfaces of these. Thus, the cured injection material 42, for example PU that may have an increased stiffness and rigidity as compared to the material of the SCF sole part, may provide an increased rigidity in a direction along the direction of the one or more indentations. Hereby, the e.g. softness and the flexibility of the e.g. outsole comprising the premanufactured sole part 80 may be designed by the lay-out of the at least one indentation 82 and/or by the depth of the at least one indentation.

The scenario shown in FIG. 7a corresponds to FIG. 7, but in FIG. 7a it is shown that as described in connection with FIG. 6a a bonding layer 86 may be applied, e.g. a thin layer placed on the surface of the premanufactured sole part 80 to facilitate that the injection material, when cured, is solidly adhered to the premanufactured sole part 80. In FIG. 7a it is shown that the bonding layer 86 may not be applied to parts of the indentations 82, e.g. the bottom and/or the sides of the indentations. Hereby, the adherence to the indentations may thus be lessened, which may be taken into consideration when configuring e.g. the variable hardness and the comfort of the sole structure as it will be elucidated later on.

As noted above, a bonding layer 86 may comprise materials such as glue, adhesive, textile, woven or non-woven materials, scrim, etc.

In case of applying glue as a bonding layer, various glues may be utilized such as for example Glue Loctite Bondace 2520-2, Hardener Loctite Bondace RFE TH (TPFE), Hardener Loctite Bondace ARF-12, Glue Loctite Bondace 223-2, Hardener Loctite Bondace ARF-1000, etc. However, it will be apparent to a skilled person that other types and variants may be used.

It will be understood that the one or more indentations 82 may have a multitude of forms, shapes, depths, vertical angles, etc. Further, it will be understood that the one or more indentations 82 may extend partly through or completely through the premanufactured sole part 80, that the one or more indentations 82 may be positioned within the premanufactured sole part 80 or in the perimeter of the premanufactured sole part 80, e.g. in the peripheral side surrounding the premanufactured sole part 80. Further, it will be understood that the one or more indentations 82 may be in the form of grooves and that such grooves may extend in the longitudinal direction of the footwear, in the transverse direction of the footwear, in a direction forming an angle in relation to the longitudinal or the transverse direction of the footwear. Even further, it will be understood that the one or more indentations 82 may extend as grooves that may take the form of a multitude of geometric shapes such as e.g. linear, circular, curved, elliptical, spiral shaped forms etc.

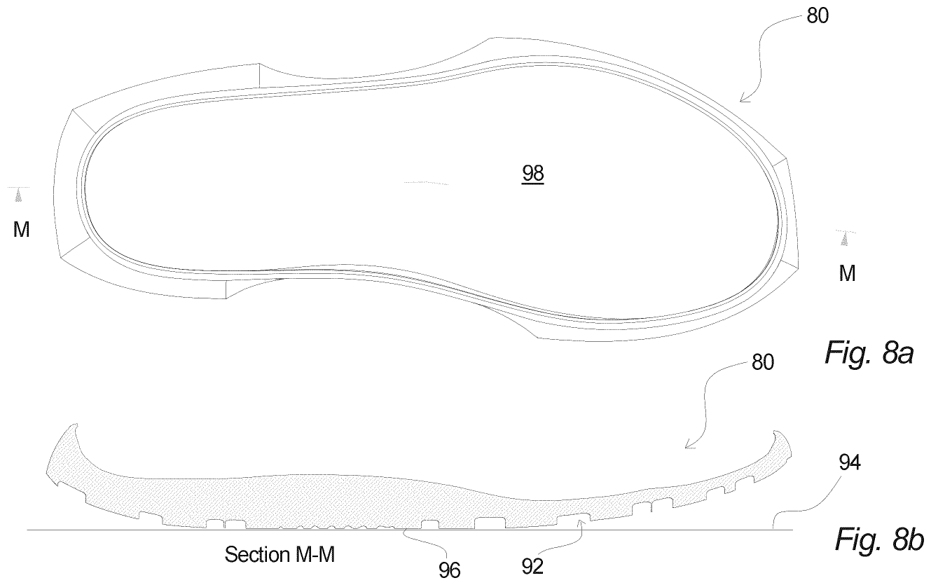

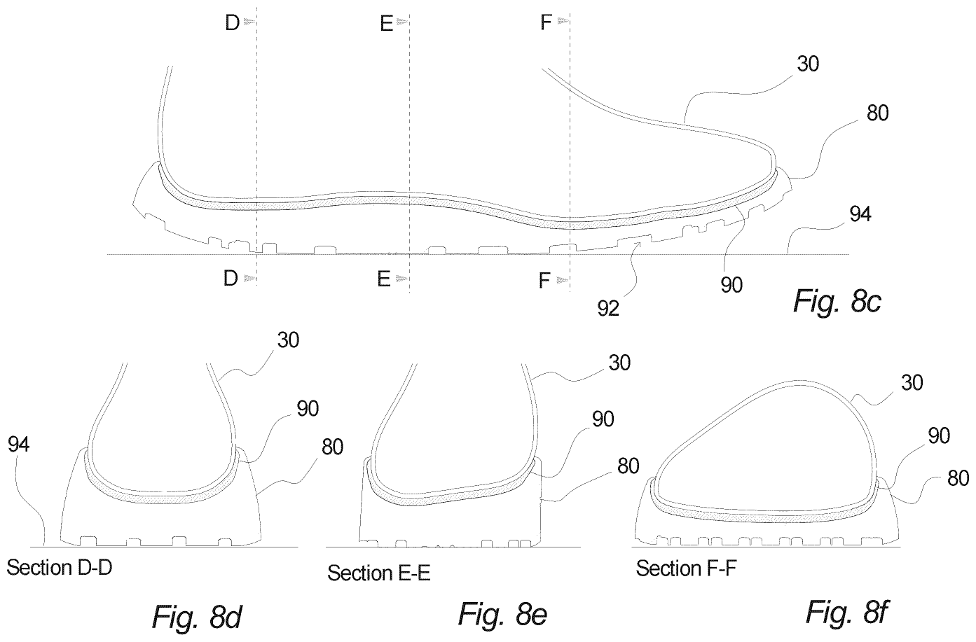

In the following various embodiments of footwear manufactured by embodiments of the invention will be exemplified with reference to FIGS. 8a-20f.

FIG. 8a shows a premanufactured sole part 80, which is manufactured by a supercritical foaming process, seen from above, i.e. showing inter alia the foot facing surface 98 and FIG. 8b shows the premanufactured sole part 80, seen in a sectional view along the line M-M in FIG. 8a. FIG. 8c shows a sectional view of a footwear along the longitudinal direction, wherein the premanufactured sole part 80 as shown in FIGS. 8a and 8b is utilized as an outsole. Furthermore, FIGS. 8d-8f show respective transverse sectional views of the footwear as shown in FIG. 8c, wherein FIG. 8d is a transverse sectional view from the heel area (along the line D-D), FIG. 8e is a transverse sectional view from the arch area (along the line E-E), and FIG. 8f is a transverse sectional view from the forefoot area (along the line F-F). As it has been explained above, the attaching sole part 90 serves for attaching the footwear upper 30 to the premanufactured sole part 80, possibly via a bonding layer 86 (not shown in FIGS. 8a-20f).

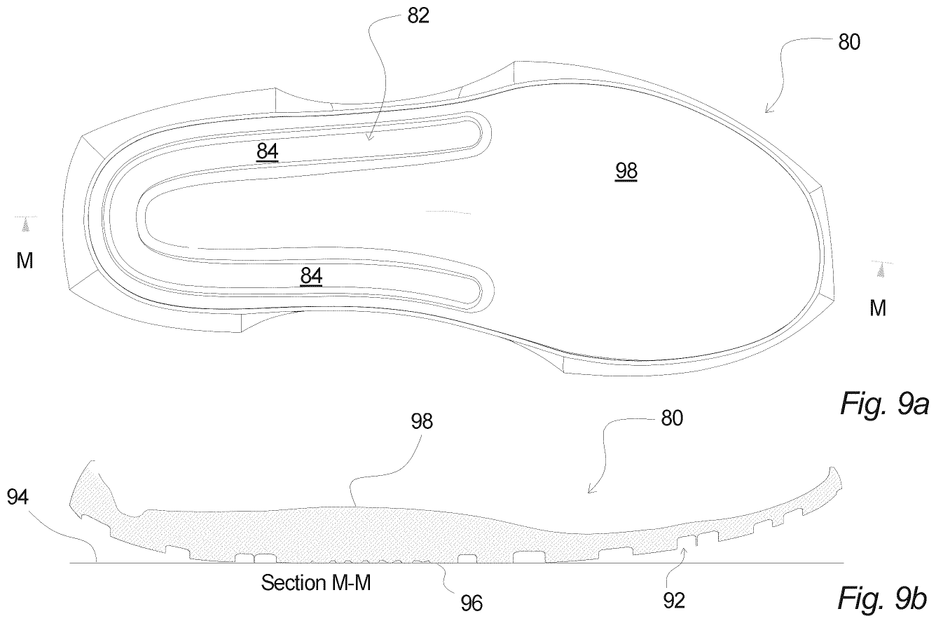

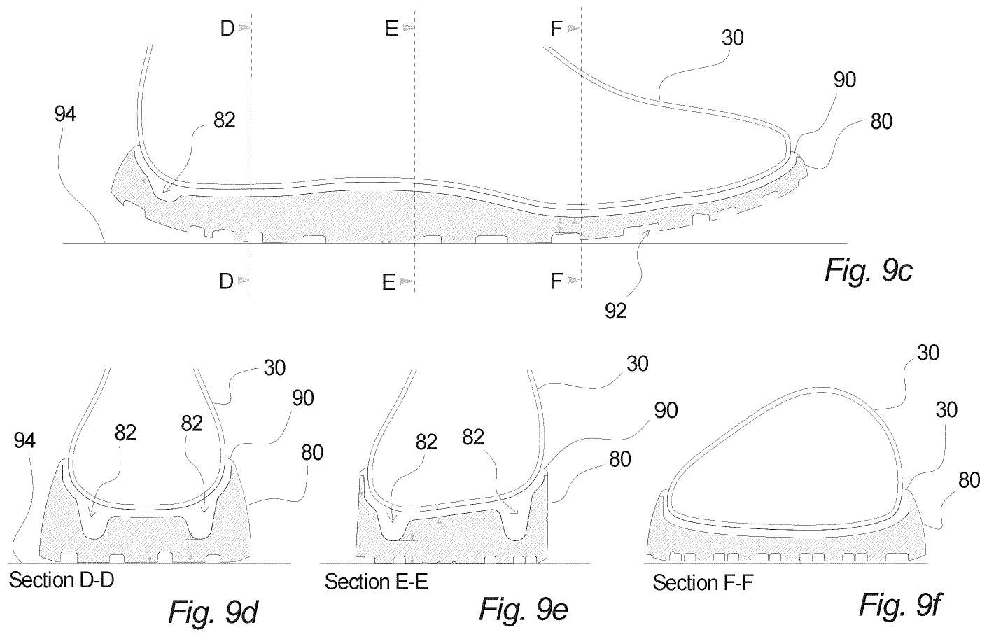

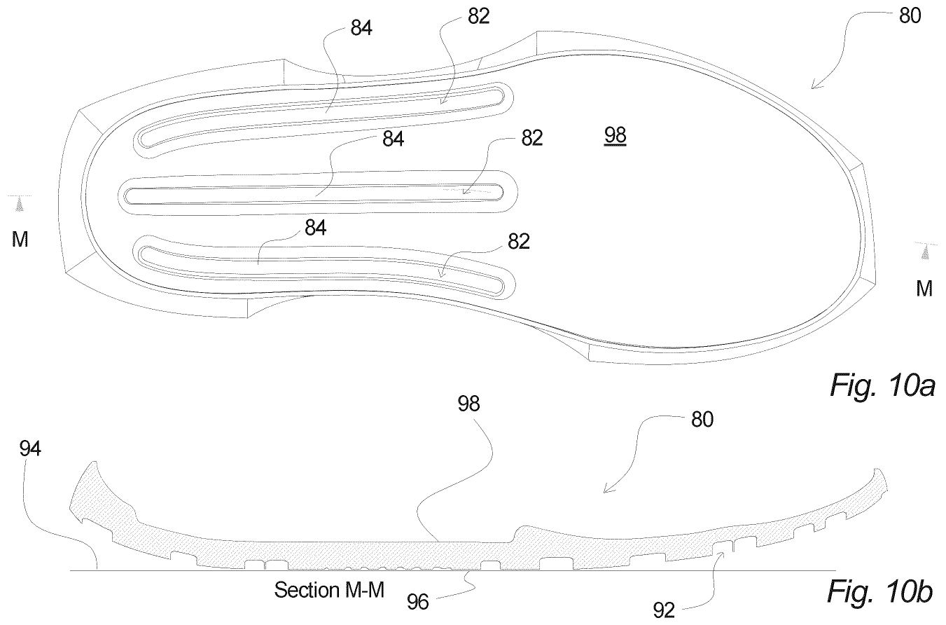

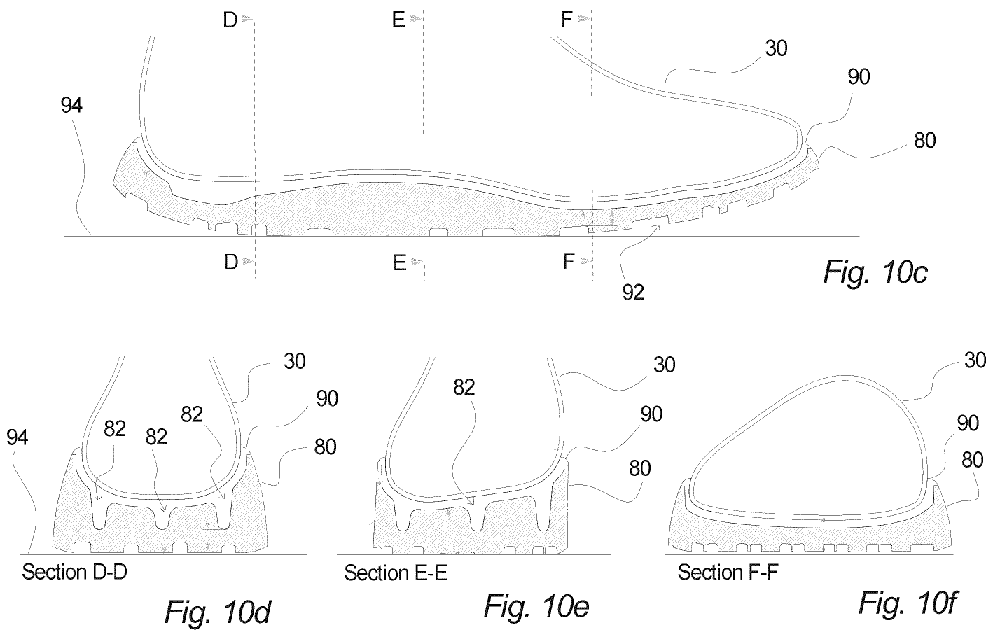

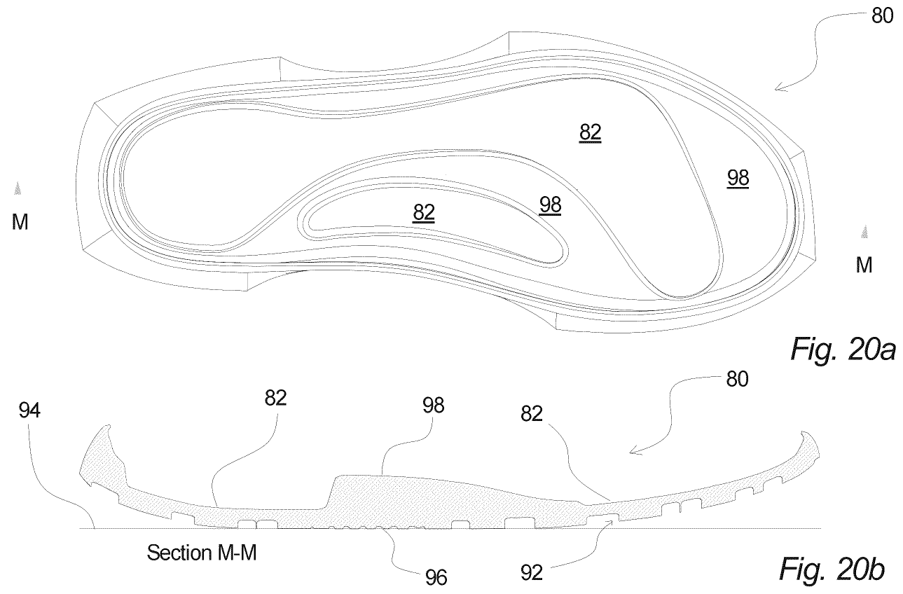

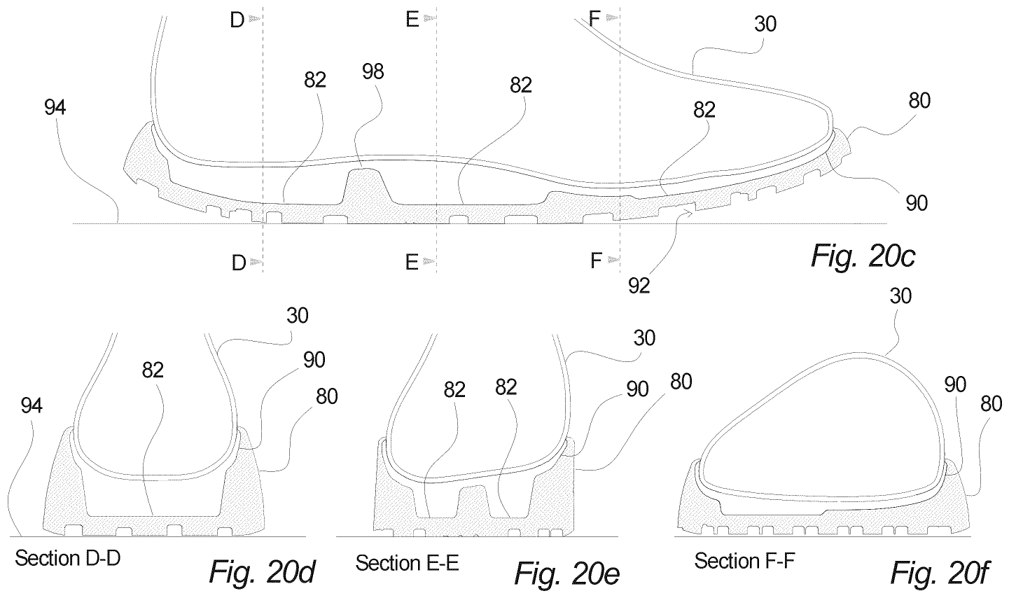

It is noted that as regards FIGS. 9a-9f, FIGS. 10a-10f, etc. up to FIGS. 20a-20f, these comprise views corresponding to the views of FIGS. 8a-8f and arranged in a corresponding order and manner. Thus, no further information will be given as regards the views and the order, in which these figures are arranged, but only comments regarding the subject matter of these figures will be explained in the following.

FIGS. 9a-f show an embodiment of a footwear manufactured by an embodiment of the invention, wherein the premanufactured sole part 80 comprises one or more indentations 82, here including indentations 82 that form a groove 84 extending along a substantial part of the heel section and at each side of the footwear and which are connected with a curved part at the heel. As shown if FIGS. 9d and 9e, this provides a configuration essentially corresponding to FIG. 7.

FIGS. 10a-f show a further embodiment, also wherein the premanufactured sole part 80 comprises indentations 82 that also are shaped as grooves 84 as three grooves are positioned essentially along each other in the rear part of the footwear.

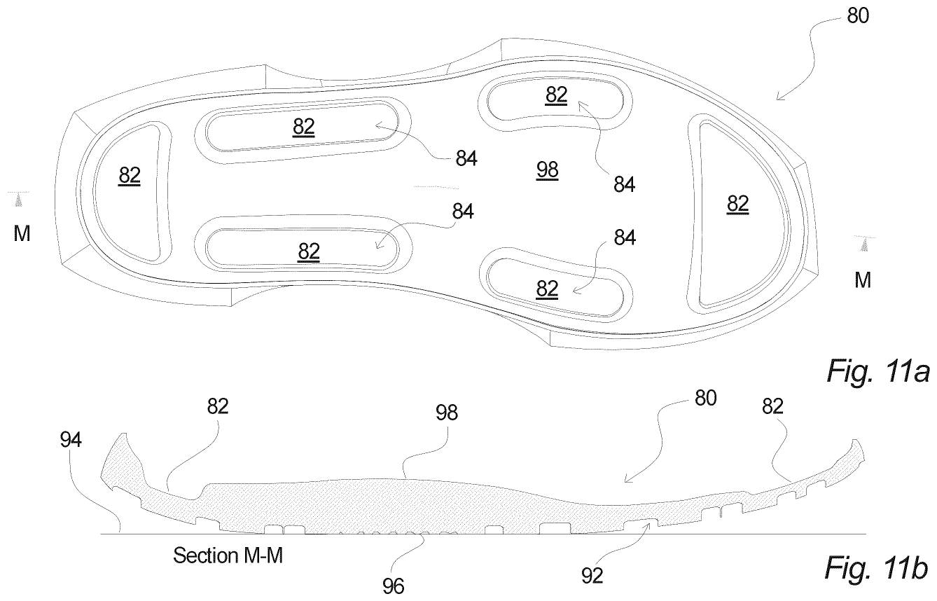

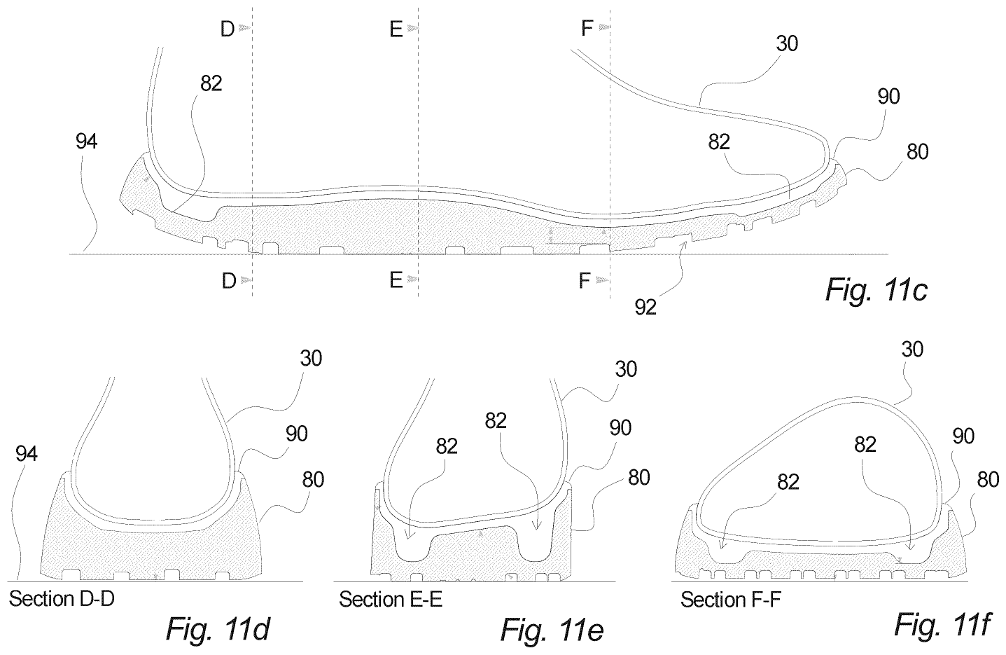

FIGS. 11a-f show a further example of a footwear manufactured by an embodiment of the invention, wherein the premanufactured sole part comprises various indentations 82, including groove shaped indentations 84 as well as indentations 82 having a larger area, e.g. shaped semi-circularly, at the heel and the toe area.

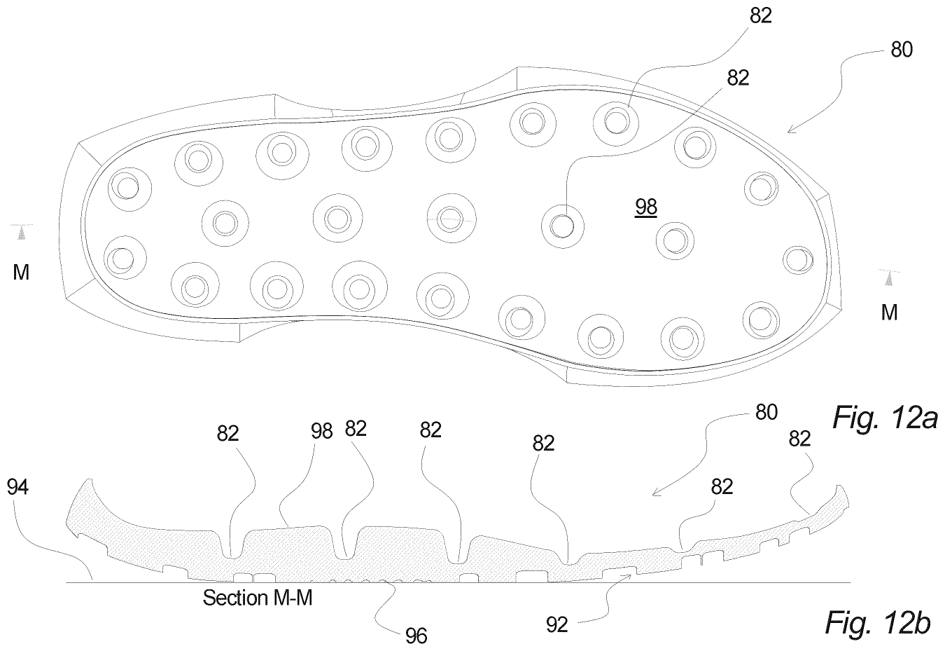

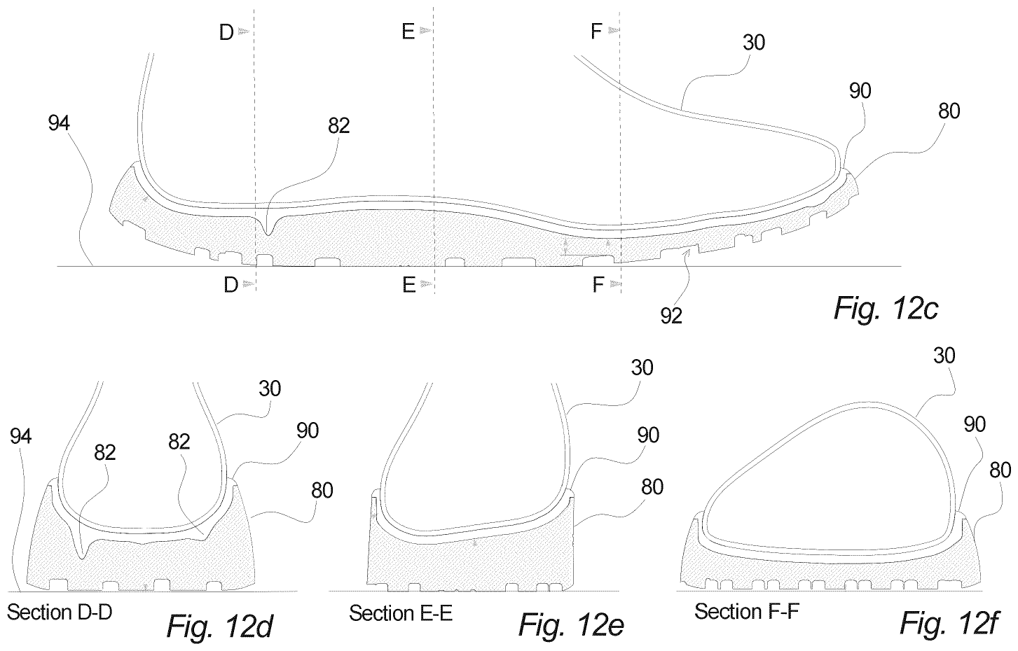

FIGS. 12a-f show a still further example of a footwear manufactured by an embodiment of the invention, wherein as illustrated in FIG. 12a, the indentations 82 are shaped as small circular holes that are distributed over the foot facing surface 98 of the premanufactured sole part 80.

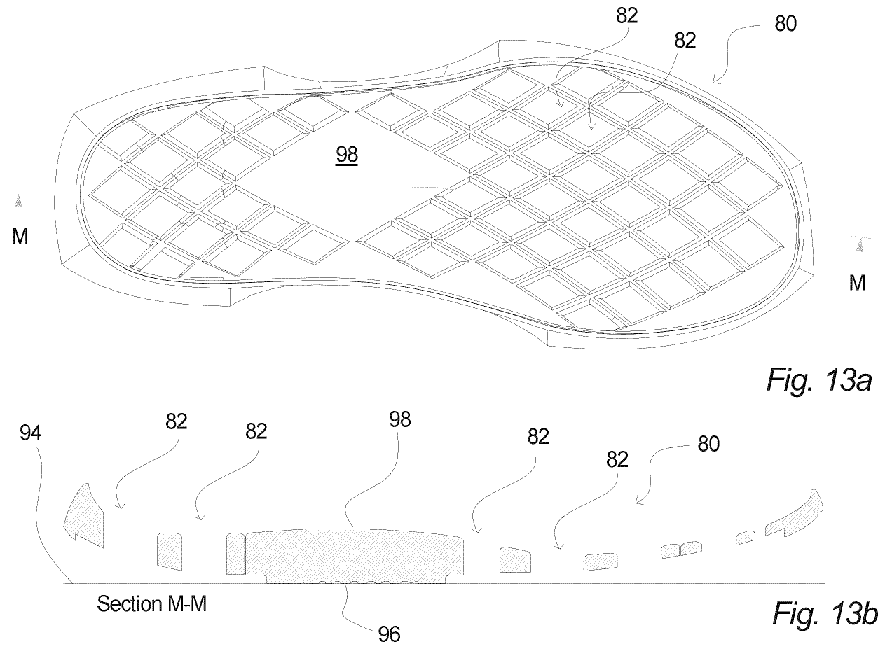

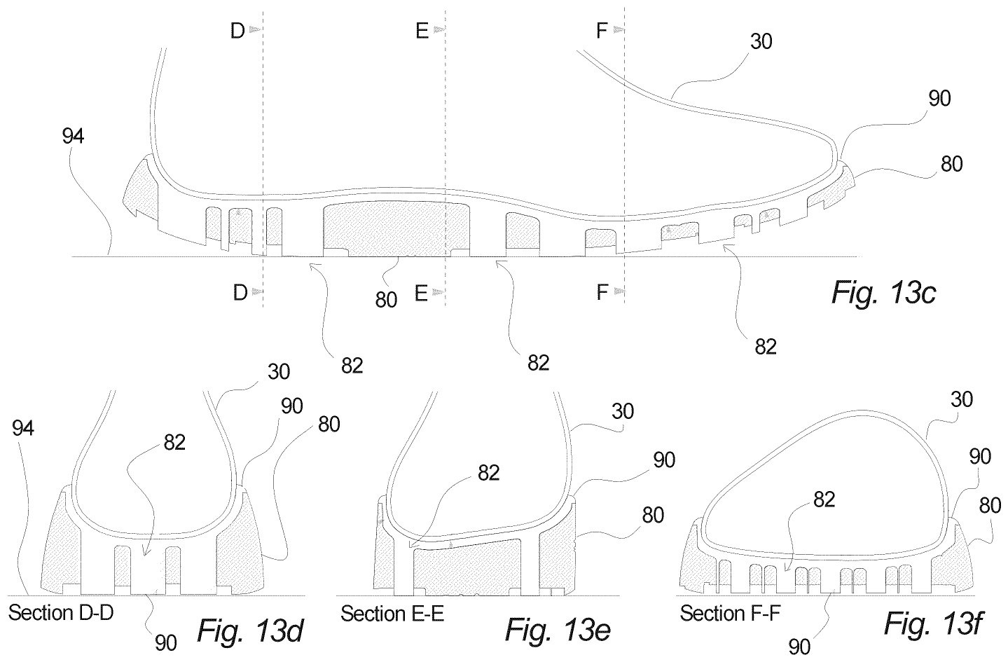

FIGS. 13a-f show a further embodiment of a footwear manufactured by an embodiment of the invention, wherein the premanufactured sole part 80 comprises indentations protruding through the sole as shown e.g. in FIGS. 13c-13f, whereby the attaching sole part 90 also serves as a ground contacting medium by the ground facing surface 96 together with the premanufactured sole part 80.

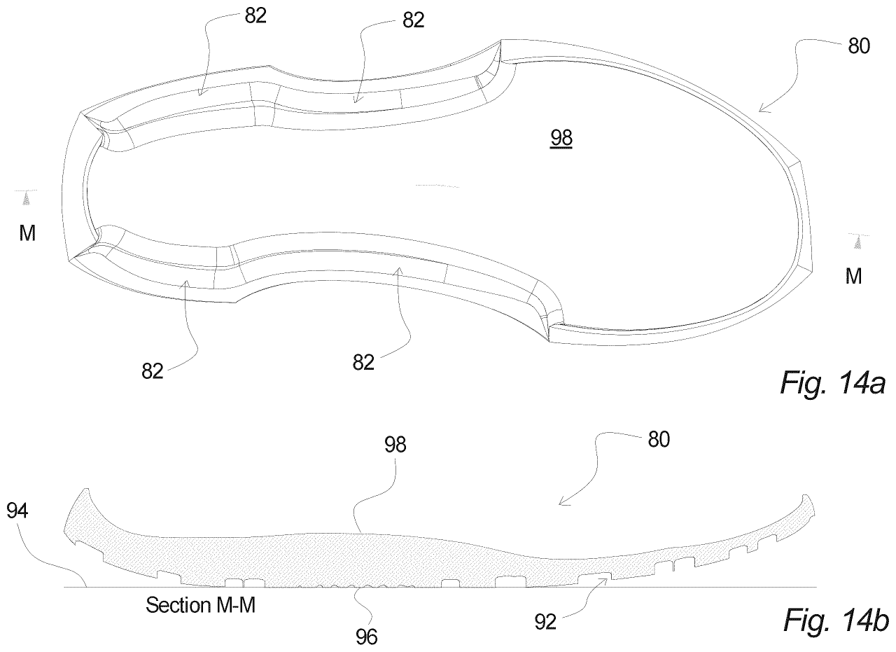

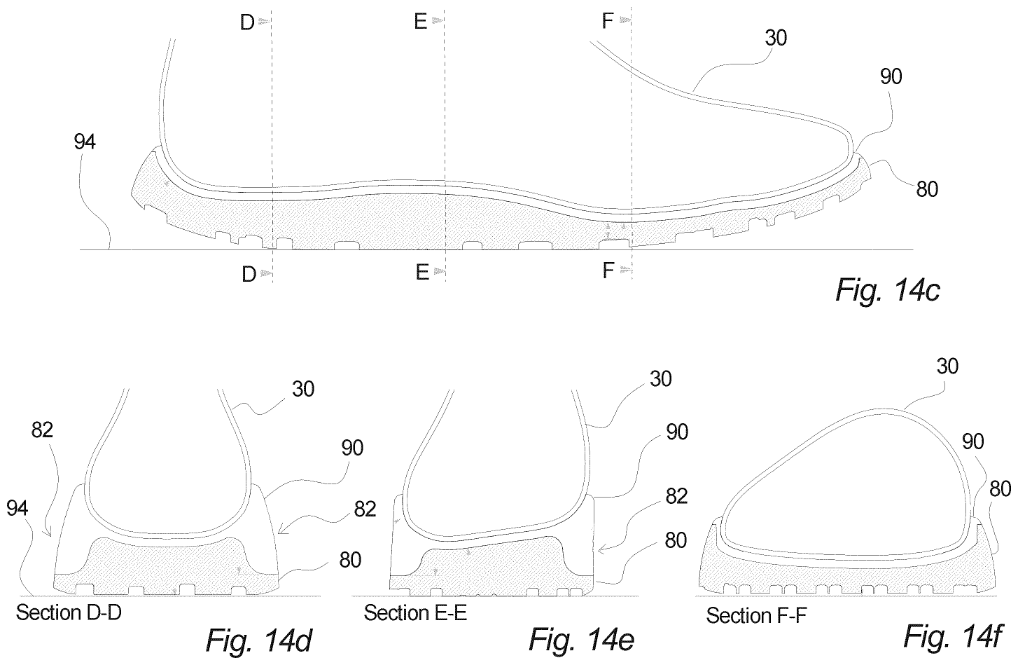

FIGS. 14a-f show an embodiment of a footwear manufactured by an embodiment of the invention, wherein the premanufactured sole part 80 comprises indentations 82 placed in the perimeter of the sole, e.g. peripherally as shown in FIG. 14a, e.g. indentations placed at the medial as well as the lateral side of the premanufactured sole part 80. As shown in FIGS. 14d and 14e, this may have the effect that a substantial part of the outer side of the sole is constituted by the cured injection material, which may be preferable in case this is e.g. stiffer or more robust than the SCF foamed material of the premanufactured sole part 80.

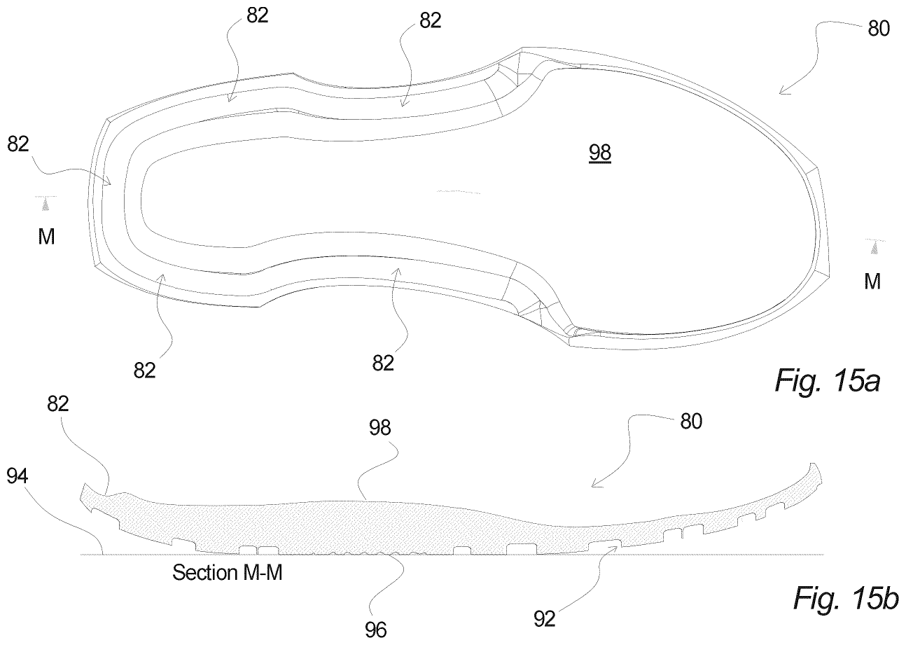

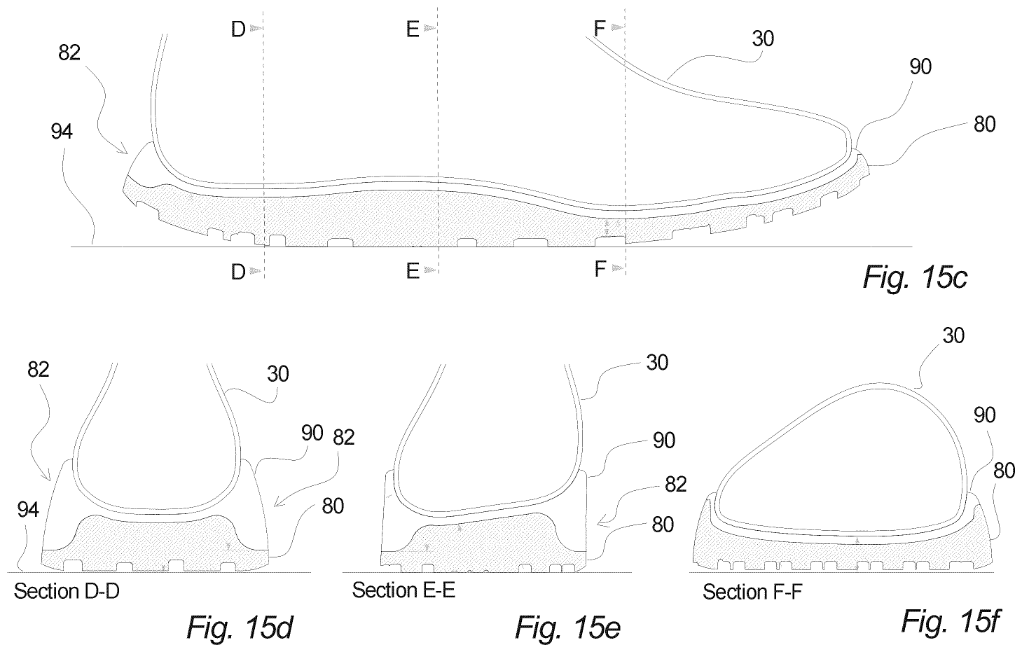

FIGS. 15a-f show an embodiment of a footwear manufactured by an embodiment of the invention, showing a further example of a premanufactured sole part 80 comprising indentations 82 placed in the perimeter of the sole. Here it is illustrated that the indentations 82 as well as being positioned in the medial and the lateral part of the sole may also be positioned at the heel part, for example being a continuous indentation along most of the perimeter of the footwear apart from the forefoot part.

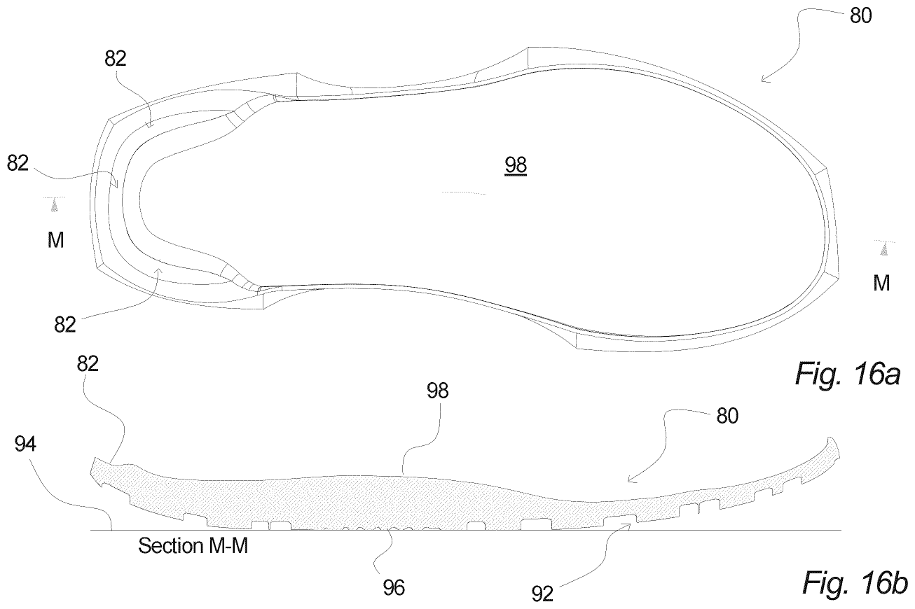

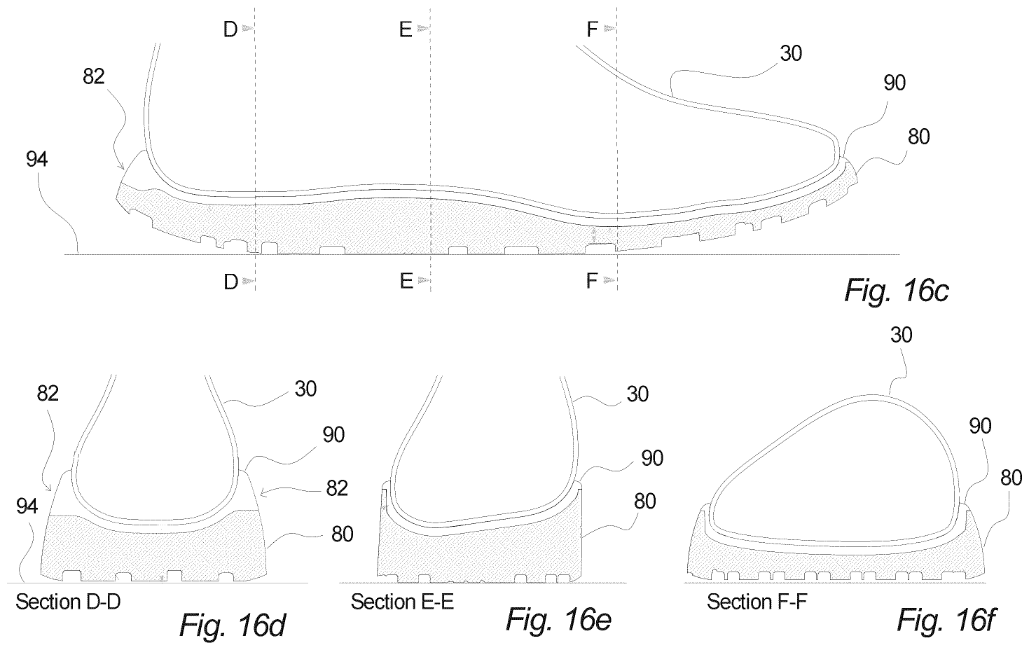

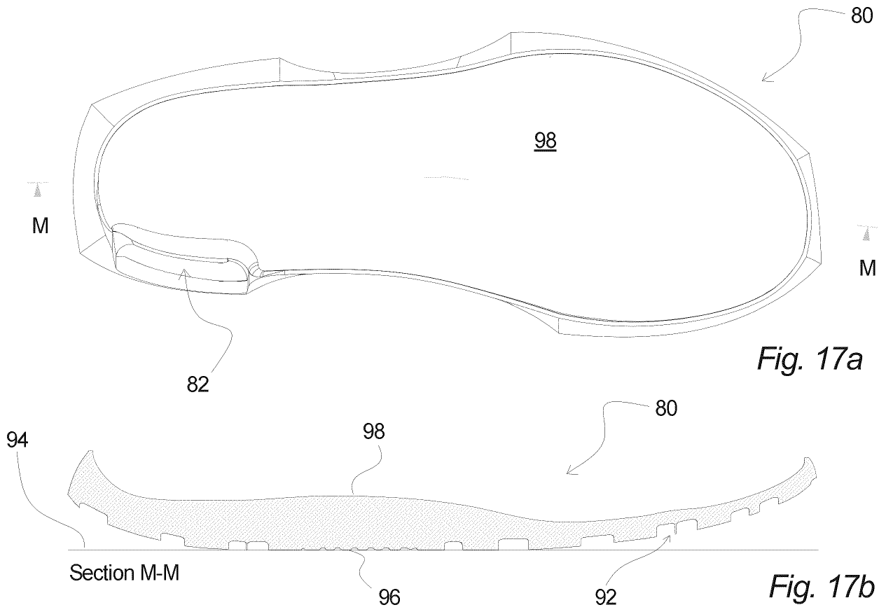

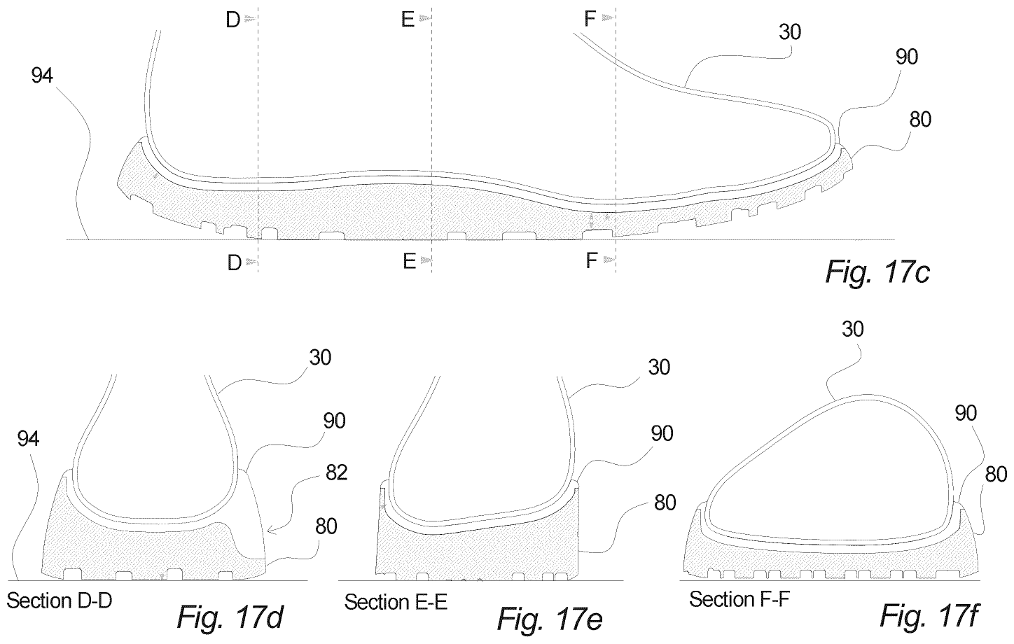

FIGS. 16a-f show an embodiment of a footwear manufactured by an embodiment of the invention, wherein the premanufactured sole part 80 comprises indentations 82 placed mainly in the perimeter of the heel part of the sole.

FIGS. 17a-f show an embodiment of a footwear manufactured by an embodiment of the invention, wherein the premanufactured sole part 80 comprises an indentation 82 placed in the perimeter at one side only of the sole, e.g. at the medial side as shown in FIG. 17a, although it may be placed in the lateral side instead or in addition.

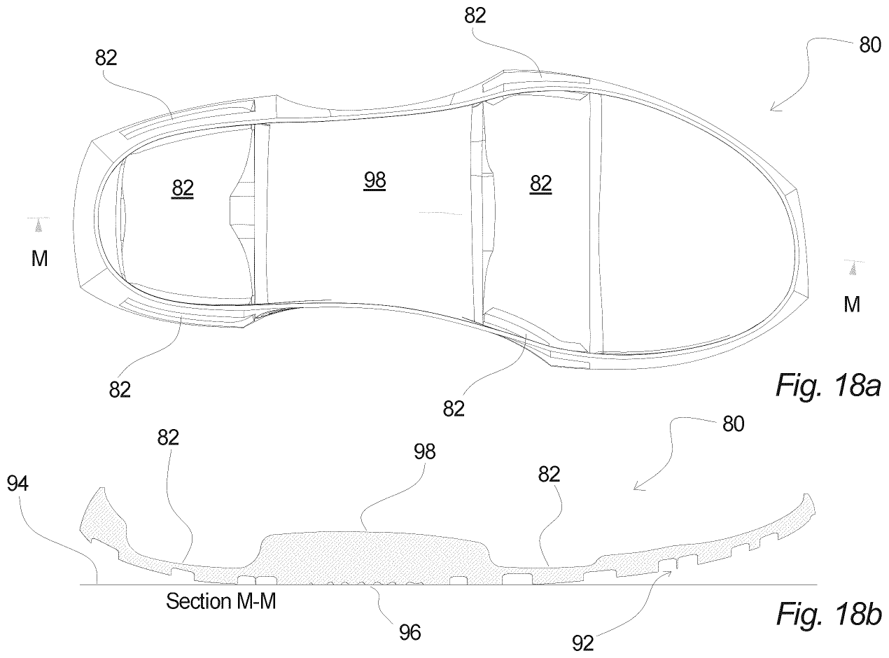

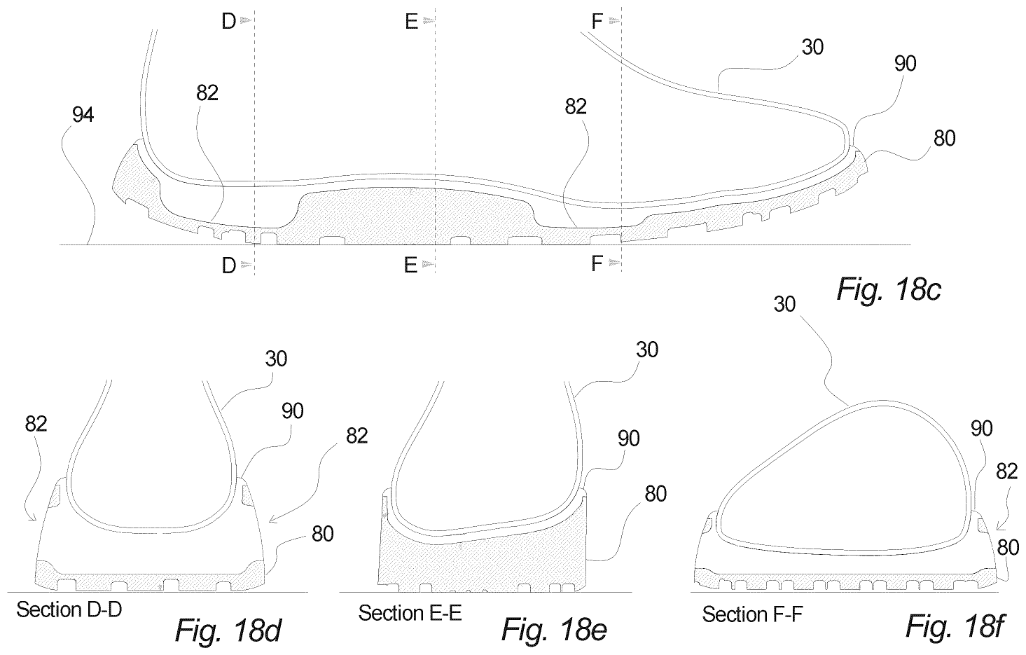

FIGS. 18a-f show an embodiment of a footwear manufactured by an embodiment of the invention, wherein the premanufactured sole part 80 comprises relatively large indentations 82, e.g. having a relatively large area as seen from above, cf. FIG. 18a, where one is placed at the heel area and one at the forefoot area. As it is illustrated in FIGS. 18d and 18f, the injected material of the attaching sole part 90 may at parts of the sole be visible from the side through an indentation 82 of the premanufactured sole part 80.

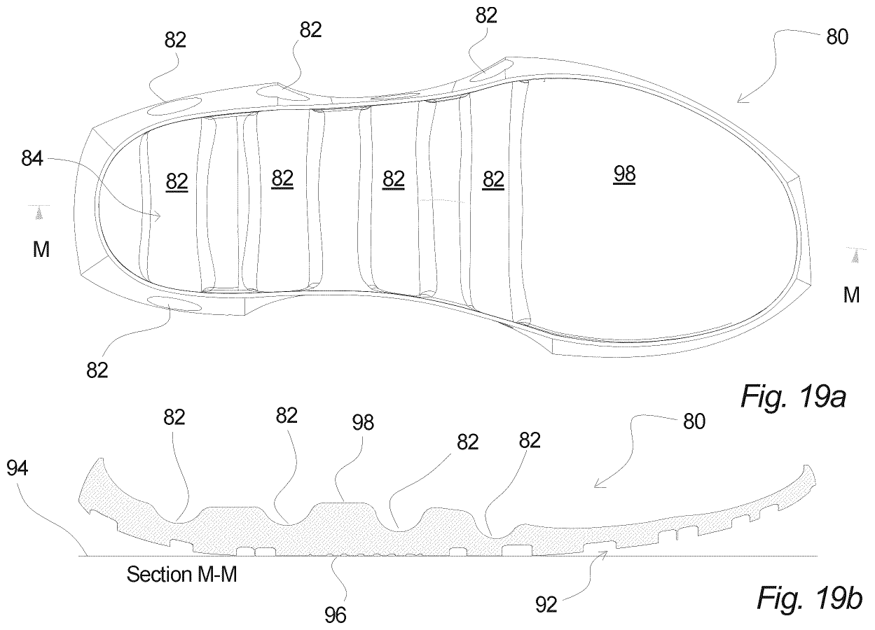

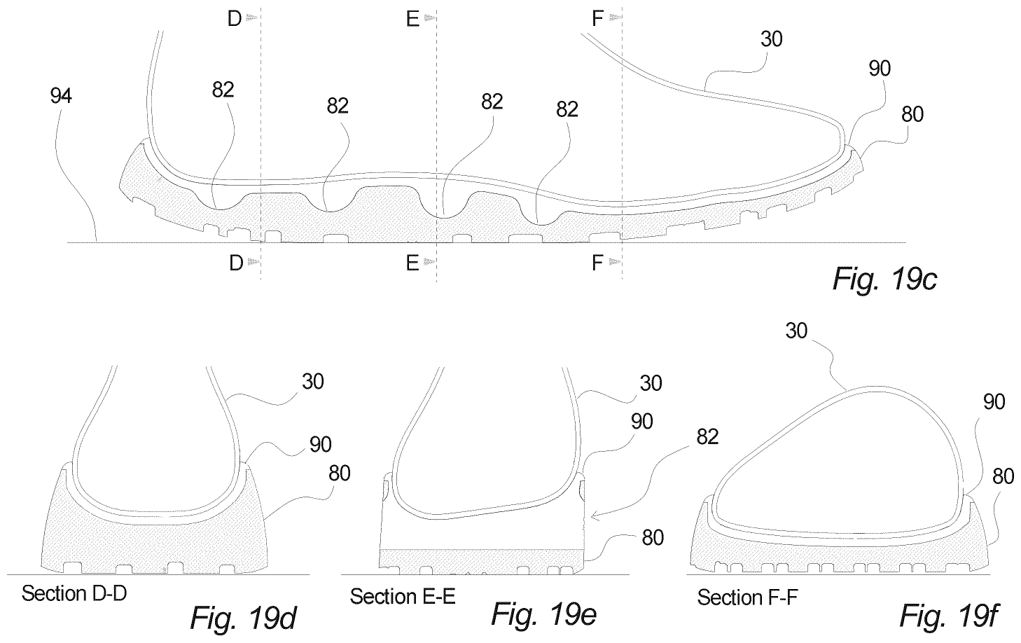

FIGS. 19a-f show an embodiment of a footwear manufactured by an embodiment of the invention, wherein the premanufactured sole part 80 comprises indentations 82 placed essentially in a transverse direction of the sole and in the form of transverse grooves 84 as seen in FIG. 19a. Further, it is shown in FIG. 19a that indentations 82, e.g. holes, apertures or the like, may be arranged in the side of the premanufactured sole part 80, whereby the material of the attaching sole part 90 is visible from the side in patterns defined by these holes, apertures or the like as also indicated in e.g. FIG. 19e.

It is noted that the indentations 82 in the form of grooves may be arranged angled in relation to the longitudinal or transverse direction of the footwear.

FIGS. 20a-f show a further embodiment of a footwear manufactured by an embodiment of the invention, wherein the premanufactured sole part 80 comprises indentations 82 formed in and distributed on the foot facing surface 98 to adapt the support and comfort functionality of the sole to the user. As shown in FIG. 20a, the premanufactured sole part 80 may comprise two relatively large indentations 82 that both may be asymmetric in relation to the line M-M or in relation to an approximate centreline (not shown) of the footwear. One of these indentations may be a smaller kidney-shaped indentation 82 positioned at the arch area and at the medial side, while the other as shown may comprise larger parts at the heel and the forefoot area, connected by a smaller length of indentation at the arch area. Other forms and variations are possible. It will be understood that by such a configuration the support of the sole, e.g. hardness, the comfort etc. may be adapted to the user, e.g. with the indentation areas, when filled with the relatively hard composition of the cured injection material as compared to the softer SCF foamed material of the premanufactured sole part 80, may provide load bearing areas, e.g. at the heel and the ball of the foot, while the softer SCF foamed material may provide a larger degree of comfort at other areas. Furthermore, it will be understood that such a “tuning” of hardness/comfort, e.g. to achieve a variable hardness, may be utilized to adapt the footwear in view of specific users, e.g. in order to provide larger support at the medial side or at the lateral side, etc.

It should be noted that other embodiments of the footwear that have been exemplified above in connection with FIGS. 8a-19f may be configured with asymmetric support/comfort configurations.

By the above examples, it is shown that the premanufactured sole part 80 and the attaching sole part 90 may be arranged in a multitude of manners, whereby desired characteristics may be achieved, e.g. as regards rigidity, flexibility, weight etc. of the footwear sole and the footwear in total. Also, it is noted that the variations may be made in order to achieve a desired design, appearance, etc.

Also, it is noted that the examples as elucidated above may be combined with each other in a multitude of ways, which will be apparent to a skilled person.

### LIST OF REFERENCE NUMBERS

2 Direct injection mould
4 First side mould
5 First side surface
6 Second side mould
7 Second side surface
8 Bottom mould
9 Bottom inner surface
20 Last
30 Footwear upper
40 Mould cavity
42 Injected material
44 Footwear sole
50 Providing a DIP mould
52 Providing a SCF sole part
54 Positioning the SCF sole part
56 Positioning a footwear upper
58 Closing the DIP mould
60 Injecting injection material
62 Curing injection material
64 Open mould
66 Remove footwear
68 Providing a basic part
70 Subject to SCF agent
72 Expand in preform
80 Premanufactured sole part
82 Indentation
84 Groove
86 Bonding layer
90 Attaching sole part
92 Tread
94 Ground
96 Ground facing surface
98 Foot facing surface

1. A method of manufacturing footwear by a direct injection production (DIP), said method comprising:
providing a direct injection mold, which is attachable to injection molding equipment and is configured for at least partly channeling injection material to a mold cavity,
providing at least one premanufactured sole part of a sole structure,
positioning the premanufactured sole part in relation to the direct injection mold,
positioning a footwear upper in relation to the direct injection mold,
injecting injection material into said mold cavity, said mould cavity being at least partly formed by said direct injection mold, said injection material configured for attaching said footwear upper to said at least one premanufactured sole part, said injection material upon curing providing an attaching sole part of the sole structure of said footwear,
wherein said at least one premanufactured sole part is a sole part that has been manufactured by a supercritical foaming process.

2. The method according to claim 1, wherein said attaching sole part that serves for attaching said footwear upper to said at least one premanufactured sole part, may serve as at least part of a further sole part of the sole structure of said footwear.

3. The method according to claim 1, wherein said at least one premanufactured sole part is configured to form an outsole or a midsole.

4.-5. (canceled)

6. The method according to claim 1, wherein said at least one premanufactured sole part is premanufactured by subjecting a basic part to a supercritical foaming agent, whereby the basic part is expanded into a preform.

7. (canceled)

8. The method according to claim 1, wherein said at least one premanufactured sole part comprises TPU (Thermoplastic Polyurethane), TPE (Thermoplastic Elastomer), Polyether Block Amide, natural rubber, synthetic rubber, ethylene vinyl acetate (EVA), or polyvinyl chloride (PVC).

9. The method according to claim 1, wherein said injection material comprises PU (Polyurethane), latex, polyvinyl chloride (PVC), or thermoplastic rubber (TR).

10. The method according to claim 1, wherein said at least one premanufactured sole part is configured with a ground facing surface and a foot facing surface, and
wherein said foot facing surface comprises at least one indentation for receiving injection material.

11.-17. (canceled)

18. The method according to claim 1, wherein said at least one premanufactured sole part comprises a bonding layer on at least part of a surface subjected to said injection material.

19. The method according to claim 18, wherein said bonding layer comprises materials selected from the group consisting of: glue, textile, woven or non-woven materials, and scrim.

20. (canceled)

21. A footwear manufactured by direct injection production (DIP), said footwear comprising:
a footwear upper;
at least one premanufactured sole part;
at least one further sole part of said footwear,
wherein said at least one premanufactured sole part is a sole part is manufactured by a super critical foaming process,
wherein said at least one further sole part of said footwear is at least partly manufactured by injecting injection material into a mold cavity that is at least partly formed by a direct injection mold, and
wherein said injection material attaches said footwear upper to said at least one premanufactured sole part.

22. The footwear according to claim 21, wherein said at least one premanufactured sole part an outsole.

23. The footwear according to claim 21, wherein said further sole part of said footwear that is at least partly provided by said injection material is a midsole.

24.-25. (canceled)

26. The footwear according to claim 21, wherein said at least one premanufactured sole part comprises TPU (Thermoplastic Polyurethane), TPE (Thermoplastic Elastomer), Polyether Block Amide, natural rubber, synthetic rubber, ethylene vinyl acetate (EVA), or polyvinyl chloride (PVC).

27. The footwear according to claim 21, wherein said injection material comprises PU (Polyurethane), latex, polyvinyl chloride (PVC), or thermoplastic rubber (TR).

28. The footwear according to claim 21, wherein said at least one premanufactured sole part is configured with a ground facing surface and a foot facing surface, and
wherein said foot facing surface comprises at least one indentation for receiving injection material.

29. The footwear according to claim 28, wherein said at least one indentation for receiving injection material forms a groove along the foot facing surface or extends through said at least one premanufactured sole part.

30.-34. (canceled)

35. The footwear according to claim 28, wherein said at least one indentation for receiving injection material is configured for providing a variable hardness or support of the sole structure.

36. The footwear according to claim 21, wherein said at least one premanufactured sole part comprises a bonding layer on at least part of a surface subjected to said injection material.

37. The footwear according to claim 36, wherein said bonding layer comprises materials selected from the group consisting of: glue, textile, woven or non-woven materials, and scrim.

38. The footwear according to claim 36, wherein at least part of said surface subjected to said injection material is void of said bonding layer.

39. (canceled)
